(19) United States
(12) Patent Application Publication
(10) Pub. No.: US 2026/0116126 A1
(43) Pub. Date: Apr. 30, 2026

(54) RUBBER COMPOSITION FOR TIRES, AND TIRE

(71) Applicants: SUMITOMO RUBBER INDUSTRIES, LTD., Kobe-shi, Hyogo (JP); NATIONAL UNIVERSITY CORPORATION HOKKAIDO UNIVERSITY, Sapporo-shi, Hokkaido (JP)

(72) Inventors: Tomohiro AKAHORI, Kobe-shi (JP); Takayuki NONOYAMA, Sapporo-shi (JP)

(73) Assignees: SUMITOMO RUBBER INDUSTRIES, LTD., Kobe-shi, Hyogo (JP); NATIONAL UNIVERSITY CORPORATION HOKKAIDO UNIVERSITY, Sapporo-shi, Hokkaido (JP)

(21) Appl. No.: 18/849,027

(22) PCT Filed: Oct. 27, 2022
(86) PCT No.: PCT/JP2022/040176

§ 371 Date: Sep. 20, 2024

(30) Foreign Application Priority Data
Apr. 11, 2022 (JP) 2022-065163

(51) Int. Cl. B60C 1/00; C08K 3/04; C08K 3/36; C08K 5/20; C08L 9/00

(52) U.S. Cl. CPC B60C 1/0016; C08K 3/04; C08K 3/36; C08K 5/20; C08L 9/00; C08L 2205/025; C08L 2205/03; C08L 2207/324

(57) ABSTRACT

The present disclosure provides a tire rubber composition and a tire which are capable of changing tire performance in response to temperature changes. The present disclosure relates to a tire rubber composition containing: a rubber component including at least one selected from the group consisting of polyisoprene rubber, polybutadiene rubber, and styrene-butadiene rubber; a cross-linking agent; carbon black; a plasticizer; and a temperature-responsive material A containing a carboxyl group-containing polymer and a metal salt, the tire rubber composition containing, per 100 parts by mass of the rubber component, the cross-linking agent in an amount of more than 0 parts by mass and less than 10 parts by mass, the carbon black in an amount of more than 0 parts by mass and less than 100 parts by mass, and the plasticizer in an amount of more than 5 parts by mass.

### TECHNICAL FIELD

The present disclosure relates to a tire rubber composition and a tire.

### BACKGROUND ART

Tires have been required to have various performances. In particular, all-season tires need to cope with large changes in external temperature and changes in road surface conditions.

### SUMMARY OF INVENTION

### Technical Problem

The present disclosure aims to solve the above problem and provide a tire rubber composition and a tire which are capable of changing tire performance in response to temperature changes.

### Solution to Problem

The present disclosure relates to a tire rubber composition, containing: a rubber component including at least one selected from the group consisting of polyisoprene rubber, polybutadiene rubber, and styrene-butadiene rubber; a cross-linking agent; carbon black; a plasticizer; and a temperature-responsive material A containing a carboxyl group-containing polymer and a metal salt, the tire rubber composition containing per 100 parts by mass of the rubber component, the cross-linking agent in an amount of more than 0 parts by mass and less than 10 parts by mass, the carbon black in an amount of more than 0 parts by mass and less than 100 parts by mass, and the plasticizer in an amount of more than 5 parts by mass.

### Advantageous Effects of Invention

According to the present disclosure, the tire has a structure with the above-described feature. The present disclosure can provide a tire rubber composition and a tire which are capable of changing tire performance in response to temperature changes.

### DESCRIPTION OF EMBODIMENTS

The present disclosure relates to a tire rubber composition that contains predetermined amounts of a rubber component including at least one selected from the group consisting of polyisoprene rubber, polybutadiene rubber, and styrene-butadiene rubber, a cross-linking agent, carbon black, a plasticizer, and a temperature-responsive material A containing a carboxyl group-containing polymer and a metal salt.

To date, the tire industry has not much focused on changing tire performance in response to temperature changes. Conventional techniques have room for improvement in terms of changing tire performance in response to temperature changes. In particular, ice grip performance needs to be increased on ice at low temperature by reducing the modulus of elasticity, while handling stability needs to be increased at high temperature by improving the modulus of elasticity. A technique using a rubber that is flexible at low temperature may be a possible solution. However, the technique is disadvantageous for conventional rubber compositions in that the use of a rubber with high flexibility reduces the handling stability.

Another possible technique may be addition of a temperature-responsive material such as poly(N-isopropylacrylamide) (PNIPAM). The material is disadvantageous in that it is soluble in water at low temperature and may be dissolved in water in rainy weather or on ice, thus disappearing from a composition.

In contrast, the temperature-responsive material A in the present disclosure is a material that increases the modulus of elasticity when it absorbs water and then the temperature rises from, for example, 0° C. to 100° C. or reduces the modulus of elasticity when the temperature decreases. The use of the material can change tire performance in response to temperature changes.

The reason for the above-described advantageous effect is not completely clear, but it is believed to be as follows.

After the temperature-responsive material A in the present disclosure absorbs water, it changes the modulus of elasticity along with temperature changes, presumably thereby changing the modulus of elasticity of the rubber composition.

At least one of a water-soluble material B or a water-absorbent material B added as needed is assumed to promote the absorption of water into the temperature-responsive material A. This may be because at least one of a water-soluble material B or a water-absorbent material B which is immersed in water, for example, is dissolved in water or absorbs water, so that voids are formed in the rubber.

Thus, presumably, tire performance changes in response to temperature changes caused by immersion in water, for example.

The tire rubber composition contains a rubber component including at least one selected from the group consisting of polyisoprene rubber, polybutadiene rubber (BR), and styrene-butadiene rubber (SBR). To better achieve the advantageous effect, the tire rubber composition preferably contains at least one of an isoprene-based rubber and BR, more preferably contains both an isoprene-based rubber and BR.

The rubber component usable in the rubber composition contributes to cross-linking and is a polymer component that usually has a weight average molecular weight (Mw) of 10,000 or more and is not extracted with acetone. The rubber component is in a solid state at room temperature (25° C.).

The weight average molecular weight of the rubber component is preferably 50,000 or more, more preferably 150,000 or more, still more preferably 200,000 or more, while it is preferably 2,000,000 or less, more preferably 1,500,000 or less, still more preferably 1,000,000 or less. When the weight average molecular weight is within the range indicated above, the advantageous effect tends to be better achieved.

Herein, the weight average molecular weight (Mw) can be determined with a gel permeation chromatograph (GPC) (GPC-8000 series available from Tosoh Corporation, detector: differential refractometer, column: TSKgel SuperMultipore HZ-M available from Tosoh Corporation). The resulting value is calibrated with polystyrene standards.

Each rubber component such as polyisoprene rubber, BR, or SBR may be an unmodified rubber or a modified rubber.

The modified rubber may be any rubber having a functional group interactive with fillers such as silica. Examples of the modified rubber include a chain end-modified rubber obtained by modifying at least one chain end of a rubber by a compound (modifier) having the functional group (i.e., a chain end-modified rubber terminated with the functional group); a backbone-modified rubber having the functional group in the backbone; a backbone- and chain end-modified rubber having the functional group in both the backbone and chain end (e.g., a backbone- and chain end-modified rubber in which the backbone has the functional group and at least one chain end is modified by the modifier); and a chain end-modified rubber into which a hydroxy or epoxy group has been introduced by modification (coupling) with a polyfunctional compound having two or more epoxy groups in the molecule.

Examples of the functional group include an amino group, an amide group, a silyl group, an alkoxysilyl group, an isocyanate group, an imino group, an imidazole group, a urea group, an ether group, a carbonyl group, an oxycarbonyl group, a mercapto group, a sulfide group, a disulfide group, a sulfonyl group, a sulfinyl group, a thiocarbonyl group, an ammonium group, an imide group, a hydrazo group, an azo group, a diazo group, a carboxyl group, a nitrile group, a pyridyl group, an alkoxy group, a hydroxy group, an oxy group, and an epoxy group. These functional groups may be substituted. Preferred among these are amino groups (preferably amino groups whose hydrogen atom is replaced with a C1-C6 alkyl group), alkoxy groups (preferably C1-C6 alkoxy groups), and alkoxysilyl groups (preferably C1-C6 alkoxysilyl groups).

Usable rubbers also include hydrogenated rubbers.

Examples of the isoprene-based rubber include natural rubbers (NR), polyisoprene rubber (IR), refined NR, modified NR, and modified IR. Examples of the NR include those commonly used in the rubber industry such as SIR20, RSS #3, and TSR20. Any IR may be used, and examples include those commonly used in the rubber industry such as IR2200. Examples of the refined NR include deproteinized natural rubbers (DPNR) and ultra pure natural rubbers (UPNR). Examples of the modified NR include epoxidized natural rubbers (ENR), hydrogenated natural rubbers (HNR), and grafted natural rubbers. Examples of the modified IR include epoxidized polyisoprene rubbers, hydrogenated polyisoprene rubbers, and grafted polyisoprene rubbers. Modified isoprene-based rubbers having the functional groups described above for the modified rubbers are also usable. Each of these may be used alone or in combinations of two or more.

The amount of the isoprene-based rubber, if present, in the rubber composition based on 100% by mass of the rubber component is preferably 5% by mass or more, more preferably 20% by mass or more, still more preferably 30% by mass or more. The upper limit is preferably 60% by mass or less, more preferably 50% by mass or less, still more preferably 40% by mass or less. When the amount is within the range indicated above, the advantageous effect tends to be better achieved.

Non-limiting examples of the BR may include high-cis BR having a high cis content, BR containing syndiotactic polybutadiene crystals, and BR synthesized using rare earth catalysts (rare earth-catalyzed BR). Each of these may be used alone or in combinations of two or more. The BR preferably includes high-cis BR having a cis content of 90% by mass or higher. The cis content is more preferably 95% by mass or higher, still more preferably 98% by mass or higher. The upper limit is not limited and is preferably 99% by mass or lower. The cis content can be determined by infrared absorption spectrometry.

The BR may be either unmodified BR or modified BR. Examples of the modified BR include those into which the functional groups described above for the modified rubbers have been introduced. The BR may include a hydrogenated polybutadiene rubber.

Usable commercial products of the BR may be available from Ube Industries, Ltd., JSR Corporation, Asahi Kasei Corporation, Zeon Corporation, etc.

The amount of the BR, if present, in the rubber composition based on 100% by mass of the rubber component is preferably 20% by mass or more, more preferably 50% by mass or more, still more preferably 55% by mass or more, particularly preferably 60% by mass or more. The upper limit is preferably 90% by mass or less, more preferably 80% by mass or less, still more preferably 75% by mass or less. When the amount is within the range indicated above, the advantageous effect tends to be better achieved.

Non-limiting examples of the SBR include emulsion-polymerized styrene-butadiene rubbers (E-SBR) and solution-polymerized styrene-butadiene rubbers (S-SBR). Each of these may be used alone or in combinations of two or more.

The styrene content of the SBR is preferably 1% by mass or higher, more preferably 3% by mass or higher, still more preferably 5% by mass or higher. The styrene content is preferably 30% by mass or lower, more preferably 23.5% by mass or lower, still more preferably 20% by mass or lower, further preferably 15% by mass or lower, particularly preferably 10% by mass or lower. When the styrene content is within the range indicated above, the advantageous effect tends to be better achieved.

Herein, the styrene content can be determined by 1H-NMR analysis.

The vinyl bond content of the SBR is preferably 20% by mass or higher, more preferably 35% by mass or higher, still more preferably 40% by mass or higher, particularly preferably 42% by mass or higher. The vinyl bond content is preferably 70% by mass or lower, more preferably 60% by mass or lower, still more preferably 50% by mass or lower. When the vinyl bond content is within the range indicated above, the advantageous effect tends to be better achieved.

Herein, the vinyl bond content (1,2-bond butadiene unit content) can be determined by infrared absorption spectrometry.

The SBR may be a SBR product manufactured or sold by Sumitomo Chemical Co., Ltd., JSR Corporation, Asahi Kasei Corporation, Zeon Corporation, etc.

The amount of the SBR, if present, in the rubber composition based on 100% by mass of the rubber component is preferably 5% by mass or more, more preferably 10% by mass or more, still more preferably 15% by mass or more. The upper limit is preferably 40% by mass or less, more preferably 30% by mass or less, still more preferably 25% by mass or less. When the amount is within the range indicated above, the advantageous effect tends to be better achieved.

Examples of usable rubber components other than the isoprene-based rubber, BR, and SBR include styrene-isoprene-butadiene rubber (SIBR), ethylene-propylene-diene rubber (EPDM), chloroprene rubber (CR), and acrylonitrile-butadiene rubber (NBR). Examples also include butyl-based rubbers and fluororubbers. Each of these may be used alone or in combinations of two or more.

The rubber composition contains a cross-linking agent.

The cross-linking agent may be any compound capable of cross-linking rubber components. Examples include known cross-linking agents in the tire field, such as sulfur, an organic cross-linking agent, an organic peroxide, and a resin cross-linking agent. To better achieve the advantageous effect, sulfur is desirable among these.

The amount of the cross-linking agent (total amount of cross-linking agents) per 100 parts by mass of the rubber component in the rubber composition is more than 0 parts by mass and less than 10 parts by mass. The lower limit is preferably 0.6 parts by mass or more, more preferably 0.9 parts by mass or more, still more preferably 1.2 parts by mass or more, particularly preferably 1.5 parts by mass or more. The upper limit is preferably 5.0 parts by mass or less, more preferably 3.0 parts by mass or less, still more preferably 2.5 parts by mass or less, particularly preferably 2.0 parts by mass or less. When the amount is within the range indicated above, the advantageous effect tends to be better achieved.

Examples of the sulfur include those commonly used as cross-linking agents in the rubber industry, such as powdered sulfur, precipitated sulfur, colloidal sulfur, insoluble sulfur, highly dispersible sulfur, and soluble sulfur. Usable sulfur may include commercial products available from Tsurumi Chemical Industry Co., Ltd., Karuizawa sulfur Co., Ltd., Shikoku Chemicals Corporation, Flexsys, Nippon Kanryu Industry Co., Ltd., Hosoi Chemical Industry Co., Ltd., etc. Each of these may be used alone or in combinations of two or more.

The amount of sulfur per 100 parts by mass of the rubber component in the rubber composition is preferably 0.6 parts by mass or more, more preferably 0.9 parts by mass or more, still more preferably 1.2 parts by mass or more, particularly preferably 1.5 parts by mass or more, while it is preferably 5.0 parts by mass or less, more preferably 3.0 parts by mass or less, still more preferably 2.5 parts by mass or less, particularly preferably 2.0 parts by mass or less. When the amount is within the range indicated above, the advantageous effect tends to be better achieved.

Non-limiting examples of the organic cross-linking agent include maleimide compounds, alkylphenol-sulfur chloride condensates, organic peroxides, and amine organosulfides. Each of these may be used alone or in combinations of two or more.

The amount of organic cross-linking agents per 100 parts by mass of the rubber component in the rubber composition is preferably 0.6 parts by mass or more, more preferably 0.9 parts by mass or more, still more preferably 1.2 parts by mass or more, particularly preferably 1.5 parts by mass or more, while it is preferably 5.0 parts by mass or less, more preferably 3.0 parts by mass or less, still more preferably 2.5 parts by mass or less, particularly preferably 2.0 parts by mass or less. When the amount is within the range indicated above, the advantageous effect tends to be better achieved.

Examples of the organic peroxide include benzoyl peroxide, dicumyl peroxide, di-t-butyl peroxide, t-butylcumyl peroxide, methyl ethyl ketone peroxide, cumene hydroperoxide, 2,5-dimethyl-2,5-di(t-butylperoxy)hexane, 2,5-dimethyl-2,5-di(benzoylperoxy)hexane, 2,5-dimethyl-2,5-di(t-butylperoxy)hexin-3, and 1,3-bis(t-butylperoxypropyl)benzene. Each of these may be used alone or in combinations of two or more.

The amount of organic peroxides per 100 parts by mass of the rubber component in the rubber composition is preferably 0.6 parts by mass or more, more preferably 0.9 parts by mass or more, still more preferably 1.2 parts by mass or more, particularly preferably 1.5 parts by mass or more, while it is preferably 5.0 parts by mass or less, more preferably 3.0 parts by mass or less, still more preferably 2.5 parts by mass or less, particularly preferably 2.0 parts by mass or less. When the amount is within the range indicated above, the advantageous effect tends to be better achieved.

Non-limiting examples of the resin cross-linking agent include phenol resins, melamine-formaldehyde resins, triazine-formaldehyde condensates, hexamethoxymethyl-melamine resins, and alkylphenol-sulfur chloride condensates. From the standpoint of the advantageous effect of the present disclosure, alkylphenol-sulfur chloride condensates are suitable.

The alkylphenol-sulfur chloride condensates are not limited. To obtain low heat-generation properties, hardness, and the like and to suppress reversion, the alkylphenol-sulfur chloride condensates are preferably compounds represented by the following formula (II).

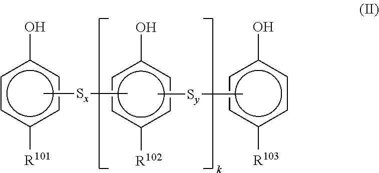

In the formula, R¹⁰¹, R¹⁰² and R¹⁰³ are the same or different from each other and each represent a C5-C12 alkyl group, x and y are the same or different from each other and each represent an integer of 1 to 3, and k represents an integer of 0 to 250.

To allow the alkylphenol-sulfur chloride condensates to well disperse in the rubber component, k is preferably an integer of 0 to 250, more preferably an integer of 0 to 100. To efficiently obtain high hardness, both x and y are preferably 2. To allow the alkylphenol-sulfur chloride condensates to well disperse in the rubber component, R¹⁰¹ to R¹⁰³ are each preferably a C6-C9 alkyl group.

The alkylphenol-sulfur chloride condensates can be prepared by a known method, such as a method involving a reaction of alkylphenol with sulfur chloride at a molar ratio of 1:0.9 to 1.25. Specific examples of the alkylphenol-sulfur chloride condensates include TACKIROL V200 (represented by the formula (II-1) below) available from Taoka Chemical Co., Ltd.

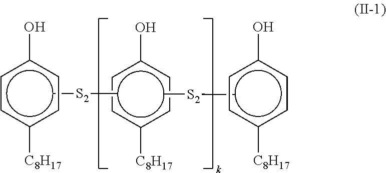

In the formula, k represents an integer of 0 to 100.

The amount of resin cross-linking agents per 100 parts by mass of the rubber component in the rubber composition is preferably 0.6 parts by mass or more, more preferably 0.9 parts by mass or more, still more preferably 1.2 parts by mass or more, particularly preferably 1.5 parts by mass or more, while it is preferably 5.0 parts by mass or less, more preferably 3.0 parts by mass or less, still more preferably 2.5 parts by mass or less, particularly preferably 2.0 parts by mass or less. When the amount is within the range indicated above, the advantageous effect tends to be better achieved.

Usable commercial products of the cross-linking agent may be available from Tsurumi Chemical Industry Co., Ltd., Karuizawa sulfur Co., Ltd., Shikoku Chemicals Corporation, Flexsys, Nippon Kanryu Industry Co., Ltd., Hosoi Chemical Industry Co., Ltd., etc. Each of these may be used alone or in combinations of two or more.

The rubber composition contains carbon black.

Non-limiting examples of the carbon black include N134, N110, N220, N234, N219, N339, N330, N326, N351, N550, and N762. Usable commercial products may be available from Asahi Carbon Co., Ltd., Cabot Japan K.K., Tokai Carbon Co., Ltd., Mitsubishi Chemical Corporation, Lion Corporation, NSCC Carbon Co., Ltd., Columbia Carbon, etc. Each of these may be used alone or in combinations of two or more.

The nitrogen adsorption specific surface area (N₂SA) of the carbon black is preferably 30 m²/g or more, more preferably 50 m²/g or more, still more preferably 70 m²/g or more. The N₂SA is preferably 200 m²/g or less, more preferably 150 m²/g or less, still more preferably 130 m²/g or less, particularly preferably 120 m²/g or less, most preferably 111 m²/g or less. When the N₂SA is within the range indicated above, the advantageous effect tends to be better achieved.

The N₂SA of the carbon black can be determined in accordance with JIS K 6217-2:2001.

The amount of the carbon black per 100 parts by mass of the rubber component in the rubber composition is more than 0 parts by mass and less than 100 parts by mass. The lower limit is preferably 3 parts by mass or more, more preferably 5 parts by mass or more, still more preferably 7 parts by mass or more, particularly preferably 10 parts by mass or more. The upper limit is preferably 50 parts by mass or less, more preferably 30 parts by mass or less, still more preferably 25 parts by mass or less, particularly preferably 20 parts by mass or less. When the amount is within the range indicated above, the advantageous effect tends to be better achieved.

The rubber composition desirably contains different fillers other than the carbon black. Examples of the different fillers include inorganic fillers such as silica, calcium carbonate, talc, alumina, clay, aluminum hydroxide, aluminum oxide, and mica. To better achieve the advantageous effect, silica is desirable among these.

Non-limiting examples of the silica include dry silica (anhydrous silica) and wet silica (hydrous silica). Wet silica is preferred among these because it contains a large number of silanol groups.

The nitrogen adsorption specific surface area (N₂SA) of the silica is preferably 30 m²/g or more, more preferably 100 m²/g or more, still more preferably 125 m²/g or more. The N₂SA of the silica is preferably 300 m²/g or less, more preferably 250 m²/g or less, still more preferably 200 m²/g or less, particularly preferably 175 m²/g or less. When the N₂SA is within the range indicated above, the advantageous effect can be suitably achieved.

The N₂SA of the silica is determined by the BET method in accordance with ASTM D3037-93.

Usable commercial products of the silica may be available from Evonik Degussa, Rhodia, Tosoh Silica Corporation, Solvay Japan, Tokuyama Corporation, etc.

The amount of silica per 100 parts by mass of the rubber component in the rubber composition is preferably 30 parts by mass or more, more preferably 50 parts by mass or more, still more preferably 55 parts by mass or more, particularly preferably 60 parts by mass or more. The upper limit of the amount is not limited and is preferably 150 parts by mass or less, more preferably 100 parts by mass or less, still more preferably 80 parts by mass or less, particularly preferably 70 parts by mass or less. When the amount is within the range indicated above, the advantageous effect can be suitably achieved.

The rubber composition desirably contains a silane coupling agent.

Non-limiting examples of usable silane coupling agents include silane coupling agents conventionally used with silica in the rubber industry, including: sulfide silane coupling agents such as bis(3-triethoxysilylpropyl)tetrasulfide, bis(2-triethoxysilylethyl)tetrasulfide, bis(4-triethoxysilylbutyl)tetrasulfide, bis(3-trimethoxysilylpropyl)tetrasulfide, bis(2-trimethoxysilylethyl)tetrasulfide, bis(2-triethoxysilylethyl)trisulfide, bis(4-trimethoxysilylbutyl)trisulfide, bis(3-triethoxysilylpropyl)disulfide, bis(2-triethoxysilylethyl)disulfide, bis(4-triethoxysilylbutyl)disulfide, bis(3-trimethoxysilylpropyl)disulfide, bis(2-trimethoxysilylethyl)disulfide, bis(4-trimethoxysilylbutyl)disulfide, 3-trimethoxysilylpropyl-N,N-dimethylthiocarbamoyl tetrasulfide, 2-triethoxysilylethyl-N,N-dimethylthiocarbamoyl tetrasulfide, and 3-triethoxysilylpropyl methacrylate monosulfide; mercapto silane coupling agents such as 3-mercaptopropyltrimethoxysilane, and 2-mercaptoethyltriethoxysilane; vinyl silane coupling agents such as vinyltriethoxysilane and vinyltrimethoxysilane; amino silane coupling agents such as 3-aminopropyltriethoxysilane and 3-aminopropyltrimethoxysilane; glycidoxy silane coupling agents such as γ-glycidoxypropyltriethoxysilane and γ-glycidoxypropyltrimethoxysilane; nitro silane coupling agents such as 3-nitropropyltrimethoxysilane and 3-nitropropyltriethoxysilane; and chloro silane coupling agents such as 3-chloropropyltrimethoxysilane and 3-chloropropyltriethoxysilane. Usable commercial products may be available from Evonik Degussa, Momentive, Shin-Etsu Silicone, Tokyo Chemical Industry Co., Ltd., AZmax. Co., Dow Corning Toray Co., Ltd., etc. Each of these may be used alone or in combinations of two or more.

The amount of silane coupling agents per 100 parts by mass of the silica (total 100 parts by mass of silica constituting surface-modified silica and silica other than the silica) in the rubber composition is preferably 0.1 parts by mass or more, more preferably 3 parts by mass or more, still more preferably 5 parts by mass or more, particularly preferably 7 parts by mass or more. The upper limit of the amount is preferably 50 parts by mass, more preferably 20 parts by mass or less, still more preferably 15 parts by mass or less, particularly preferably 10 parts by mass or less. When the amount is within the range indicated above, the advantageous effect tends to be better achieved.

The rubber composition contains a plasticizer.

The term “plasticizer” refers to a material that imparts plasticity to rubber components. Examples include liquid plasticizers (plasticizers which are liquid at room temperature (25° C.)) and resins (resins which are solid at room temperature (25° C.)).

The amount of the plasticizer (total amount of plasticizers) per 100 parts by mass of the rubber component in the rubber composition is more than 5 parts by mass. The lower limit is preferably 10 parts by mass or more, more preferably 15 parts by mass or more, still more preferably 20 parts by mass or more, particularly preferably 25 parts by mass or more. The upper limit is preferably 100 parts by mass or less, more preferably 60 parts by mass or less, still more preferably 50 parts by mass or less, particularly preferably 40 parts by mass or less, most preferably 35 parts by mass or less. When the amount is within the range indicated above, the advantageous effect tends to be better achieved.

Liquid plasticizers (plasticizers which are liquid at room temperature (25° C.)) usable in the rubber composition are not limited. Desirably, oils or liquid polymers (liquid resins, liquid diene-based polymers, liquid farnesene-based polymers, etc.) are used. To better achieve the advantageous effect, an oil is preferably contained. Each of these may be used alone or in combinations of two or more.

The amount of liquid plasticizers per 100 parts by mass of the rubber component in the rubber composition is preferably 10 parts by mass or more, more preferably 15 parts by mass or more, still more preferably 20 parts by mass or more, particularly preferably 25 parts by mass or more. The upper limit is preferably 100 parts by mass or less, more preferably 60 parts by mass or less, still more preferably 50 parts by mass or less, particularly preferably 40 parts by mass or less, most preferably 35 parts by mass or less. When the amount is within the range indicated above, the advantageous effect tends to be better achieved.

Examples of the oils include process oils, plant oils, and mixtures thereof. Examples of the process oils include paraffinic process oils, aromatic process oils, and naphthenic process oils. Examples of the plant oils include castor oil, cotton seed oil, linseed oil, rapeseed oil, soybean oil, palm oil, coconut oil, peanut oil, rosin, pine oil, pine tar, tall oil, corn oil, rice oil, safflower oil, sesame oil, olive oil, sunflower oil, palm kernel oil, camellia oil, jojoba oil, macadamia nut oil, and tung oil. Usable commercial products may be available from Idemitsu Kosan Co., Ltd., Sankyo Yuka Kogyo K.K., ENEOS Corporation, Olisoy, H&R, Hokoku Corporation, Showa Shell Sekiyu K.K., Fuji Kosan Co., Ltd., The Nisshin Oillio Group, etc. Process oils such as paraffinic process oils, aromatic process oils, and naphthenic process oils, and plant oils are preferred among these.

The amount of oils per 100 parts by mass of the rubber component in the rubber composition is preferably 10 parts by mass or more, more preferably 15 parts by mass or more, still more preferably 20 parts by mass or more, particularly preferably 25 parts by mass or more. The upper limit is preferably 100 parts by mass or less, more preferably 60 parts by mass or less, still more preferably 50 parts by mass or less, particularly preferably 40 parts by mass or less, most preferably 35 parts by mass or less. When the amount is within the range indicated above, the advantageous effect tends to be better achieved.

The amount of oils include the amount of extending oils of oil-extended rubbers.

Examples of the liquid resins among the liquid polymers include terpene resins (including terpene phenol resins and aromatic modified terpene resins), rosin resins, styrene resins, C5 resins, C9 resins, C5/C9 resins, dicyclopentadiene (DCPD) resins, coumarone-indene resins (including resins based on coumarone or indene alone), phenol resins, olefin resins, polyurethane resins, and acrylic resins. Hydrogenated products of these resins are also usable.

Examples of the liquid diene-based polymers among the liquid polymers include liquid styrene-butadiene copolymers (liquid SBR), liquid polybutadiene polymers (liquid BR), liquid polyisoprene polymers (liquid IR), liquid styrene-isoprene copolymers (liquid SIR), liquid styrene-butadiene-styrene block copolymers (liquid SBS block polymers), liquid styrene-isoprene-styrene block copolymers (liquid SIS block polymers), liquid farnesene polymers, and liquid farnesene-butadiene copolymers, all of which are liquid at 25° C. The chain ends or backbones of these polymers may each be modified with a polar group. Hydrogenated products of these polymers are also usable.

Usable commercial products of the liquid diene-based polymers may be available from Sartomer, Kuraray, etc.

The amount of liquid polymers per 100 parts by mass of the rubber component in the rubber composition is preferably 10 parts by mass or more, more preferably 15 parts by mass or more, still more preferably 20 parts by mass or more, particularly preferably 25 parts by mass or more. The upper limit is preferably 100 parts by mass or less, more preferably 60 parts by mass or less, still more preferably 50 parts by mass or less, particularly preferably 40 parts by mass or less. When the amount is within the range indicated above, the advantageous effect tends to be better achieved.

Examples of the resin (resin which is solid at room temperature (25° C.)) usable in the rubber composition include aromatic vinyl polymers, coumarone-indene resin, coumarone resin, indene resin, phenol resin, rosin resin, petroleum resins, terpene-based resins, and acrylic resins, all of which are solid at room temperature (25° C.). The resin may be hydrogenated. Each of these may be used alone or in combinations of two or more. Aromatic vinyl polymers, petroleum resins, and terpene-based resins are preferred among these.

The amount of the resin per 100 parts by mass of the rubber component in the rubber composition is preferably 10 parts by mass or more, more preferably 15 parts by mass or more, still more preferably 20 parts by mass or more, particularly preferably 25 parts by mass or more. The upper limit is preferably 100 parts by mass or less, more preferably 60 parts by mass or less, still more preferably 50 parts by mass or less, particularly preferably 40 parts by mass or less. When the amount is within the range indicated above, the advantageous effect tends to be better achieved.

The softening point of the resin is preferably 50° C. or higher, more preferably 55° C. or higher, still more preferably 60° C. or higher. The upper limit is preferably 160° C. or lower, more preferably 150° C. or lower, still more preferably 145° C. or lower. When the softening point is within the range indicated above, the advantageous effect tends to be better achieved. The softening point of the resin is measured in accordance with JIS K 6220-1:2001 using a ring and ball softening point measuring apparatus, and the temperature at which the ball drops down is defined as the softening temperature.

The term “aromatic vinyl polymers” refers to polymers containing aromatic vinyl monomers as structural units. Examples include resins produced by polymerization of α-methylstyrene and/or styrene. Specific examples include styrene homopolymers (styrene resins), α-methylstyrene homopolymers (α-methylstyrene resins), copolymers of α-methylstyrene and styrene, and copolymers of styrene and other monomers.

The term “coumarone-indene resins” refers to resins containing coumarone and indene as the main monomer components forming the skeleton (backbone) of the resins. Examples of monomer components which may be contained in the skeleton in addition to coumarone and indene include styrene, α-methylstyrene, methylindene, and vinyltoluene.

The term “coumarone resins” refers to resins containing coumarone as the main monomer component forming the skeleton (backbone) of the resins.

The term “indene resins” refers to resins containing indene as the main monomer component forming the skeleton (backbone) of the resins.

Examples of usable phenol resins include known polymers produced by reacting phenol with an aldehyde such as formaldehyde, acetaldehyde, or furfural in the presence of an acid or alkali catalyst. Preferred among these are those produced by the reaction in the presence of an acid catalyst, such as novolac phenol resins.

Examples of the rosin resins include rosin resins typified by natural rosins, polymerized rosins, modified rosins, and esterified compounds thereof, and hydrogenated products thereof.

Examples of the petroleum resins include C5 resins, C9 resins, C5/C9 resins, dicyclopentadiene (DCPD) resins, and hydrogenated products of these resins. DCPD resins, and hydrogenated DCPD resins are preferred among these.

The term “terpene resins” refers to polymers containing terpenes as structural units. Examples include polyterpene resins produced by polymerization of terpene compounds, and aromatic modified terpene resins produced by polymerization of terpene compounds and aromatic compounds. Examples of usable aromatic modified terpene resins include terpene-phenol resins made from terpene compounds and phenolic compounds, terpene-styrene resins made from terpene compounds and styrene compounds, and terpene-phenol-styrene resins made from terpene compounds, phenolic compounds, and styrene compounds. Examples of the terpene compounds include α-pinene and β-pinene. Examples of the phenolic compounds include phenol and bisphenol A. Examples of the aromatic compounds include styrene compounds, such as styrene and α-methylstyrene.

The term “acrylic resins” refers to polymers containing acrylic monomers as structural units. Examples include styrene acrylic resins such as those which contain carboxyl groups and are produced by copolymerization of aromatic vinyl monomer components and acrylic monomer components. Solvent-free, carboxyl group-containing styrene acrylic resins are suitably used among these.

Usable commercial resins may be available from Maruzen Petrochemical Co., Ltd., Sumitomo Bakelite Co., Ltd., Yasuhara Chemical Co., Ltd., Tosoh Corporation, Rutgers Chemicals, BASF, Arizona Chemical, Nitto Chemical Co., Ltd., Nippon Shokubai Co., Ltd., ENEOS Corporation, Arakawa Chemical Industries, Ltd., Taoka Chemical Co., Ltd., etc.

The rubber composition contains a temperature-responsive material A containing a carboxyl group-containing polymer and a metal salt.

Poly(N-isopropylacrylamide), poly(NIPAAm), is known to be a typical temperature-responsive polymer. Poly(NIPAAm) has a lower critical solution temperature (LCST), i.e., poly(NIPAAm) is soluble at a temperature lower than LCST and is precipitated (undergoes phase separation) at a temperature higher than LCST in an aqueous solution. It is also known that poly(N-isopropylacrylamide) hydrogels cause volume phase transition.

The temperature-responsive material A containing a carboxyl group-containing polymer and a metal salt has properties of a temperature-responsive hydrogel. Preferably, it has the following natures.
(1) It is transparent below the LCST, while phase separation occurs and turbidity appears above the LCST.
(2) It is soft below the LCST, while it has high strength and high toughness above the LCST. The elastic modulus and toughness increase as the temperature rises above the LCST. At and above a certain temperature, the elastic modulus sharply increases (it becomes very hard), whereas the toughness decreases due to strong phase separation.
(3) It exhibits almost no volume change around the LCST and does not exhibit a volume phase transition. The feature of the hydrogel in the present disclosure of not exhibiting a volume phase transition or the feature of exhibiting practically no volume change means that a ratio V₂/V₁ of a volume V₂ at a temperature above the LCST (for example, T₂≥LCST+5° C.) to a volume V₁ at a temperature below the LCST (for example, T₁≤LCST−5° C.) is in the range of 0.8 to 1.2, preferably from 0.85 to 1.15, more preferably from 0.98 to 1.02.
(4) The temperature-responsive phase separation is completely reversible.

The carboxyl group-containing polymer may be any carboxyl group-containing organic polymer compound. Examples include a homopolymer of a carboxyl group-containing monomer and a copolymer of a plurality of carboxyl group-containing monomers. Each of these may be used alone or in combinations of two or more.

Examples of the carboxyl group-containing monomer include an α,β-unsaturated carboxylic acid that contains one carboxyl group or two or more carboxyl groups in the molecule. Examples of the α,β-unsaturated carboxylic acid include acrylic acid, methacrylic acid, itaconic acid, maleic acid, maleic anhydride, aconitic acid, fumaric acid, and crotonic acid.

Non-limiting examples of the homopolymer include polyacrylic acid and polymethacrylic acid.

Examples of the copolymer include a copolymer of a plurality of carboxyl group-containing monomers and a copolymer of a carboxyl group-containing monomer and a monomer other than the carboxyl group-containing monomer. Non-limiting examples of the monomer other than the carboxyl group-containing monomer include acrylate monomers (for example, esters of α,β-ethylenically unsaturated carboxylic acids, hydroxyalkyl esters of α,β-ethylenically unsaturated carboxylic acids, and alkoxyalkyl esters of α,β-ethylenically unsaturated carboxylic acids), acrylamide monomers, and styrenic monomers. Each of these may be used alone or in combinations of two or more.

Non-limiting examples of the acrylate monomers include esters of α,β-ethylenically unsaturated carboxylic acids such as methyl acrylate, methyl methacrylate, ethyl acrylate, ethyl methacrylate, n-propyl acrylate, n-propyl methacrylate, isopropyl acrylate, isopropyl methacrylate, lauryl acrylate, and stearyl acrylate; hydroxyalkyl esters of α,β-ethylenically unsaturated carboxylic acids such as 2-hydroxyethyl acrylate, 2-hydroxyethyl methacrylate, and 3-hydroxypropyl methacrylate; and alkoxyalkyl esters of α,β-ethylenically unsaturated carboxylic acids such as diethylene glycol methacrylate.

Non-limiting examples of the acrylamide monomers include acrylamide and methylolmethacrylamide.

Non-limiting examples of the styrenic monomers include styrene and alkyl styrene.

From the standpoint of temperature response, the content of structural units derived from the carboxyl group-containing monomer in the copolymer is desirably 50 mol % or higher. The content is preferably 60 mol % or higher, more preferably 70 mol % or higher, still more preferably 80 mol % or higher, particularly preferably 90 mol % or higher. The upper limit is not limited and is, for example, 98 mol % or lower, more preferably 95 mol % or lower.

From the standpoint of temperature response, the amount of carboxyl groups in the carboxyl group-containing polymer is preferably 0.001 mol/g or more, more preferably 0.005 mol/g or more, still more preferably 0.007 mol/g or more, while it is preferably 0.05 mol/g or less, more preferably 0.03 mol/g or less, still more preferably 0.014 mol/g or less.

The carboxyl group-containing polymer may have a cross-linked structure.

Examples of the cross-linked structure include a chemically cross-linked structure or a physically cross-linked structure. The chemically cross-linked structure can be formed by causing cross-linking with a cross-linking agent for chemical cross-linking formation during polymer formation or after polymer formation.

In the present disclosure, the cross-linking agent for chemical cross-linking formation is not included in the cross-linking agent.

A di-functional or multi-functional monomer can be used as the cross-linking agent for chemical cross-linking formation to form a chemically cross-linked structure. Examples of the cross-linking agent include N,N′-methylenebisacrylamide (MbAAd), N,N′-ethylenebisacrylamide, diethylene glycol diacrylate, diethylene glycol dimethacrylate, polyethylene glycol diacrylate, polyethylene glycol dimethacrylate, and 1-acryloyloxy-3-methacryloyloxy-2-propanol. The amount of the cross-linking agent for chemical cross-linking formation can be determined depending on the desired degree of cross-linking and may be, for example, in the range of 0 to 10 mol % relative to the monomer concentration.

The weight average molecular weight of the carboxyl group-containing polymer is not limited. For example, the weight average molecular weight is 1,000,000 or less, preferably 500,000 or less. The lower limit is, for example, 5,000 or more, preferably 10,000 or more. In some cases, it may be impossible to actually measure the weight average molecular weight of the polymer having a cross-linked structure.

The physically cross-linked structure is formed through the formation of a salt between two carboxyl groups possessed by the carboxyl group-containing polymer and one divalent metal and/or through polymer entanglement. Formation of the physically cross-linked structure by the former technique is performed by forming a salt with a divalent metal in a polymer that has been formed without using a cross-linking agent for chemical cross-linking formation. A phenomenon where a physically cut hydrogel undergoes re-unification after the cutting is due mainly to salt formation between the carboxyl groups and the divalent metal. However, it is hypothesized that polymer entanglement also proceeds with the passage of a relatively long time and further reinforces the re-unification due to salt formation. The hydrogel having a chemically cross-linked structure may also have a physically cross-linked structure due to salt formation between two carboxyl groups possessed by the polymer and one divalent metal as well as due to the presence of polymer entanglement.

Examples of the polymerization method used to prepare the polymer include radical polymerization using a thermal initiator (thermal polymerization) and photopolymerization using a photoinitiator. Photopolymerization is preferred among these. A known initiator may be appropriately used as the polymerization initiator. Examples of the photoinitiator include α-ketoglutaric acid. The amount of the initiator relative to the monomer concentration may be in the range of 0.01 to 10 mol %, for example.

The metal salt as a component constituting the temperature-responsive material A is not limited. To better achieve the advantageous effect, the metal salt is preferably a metal salt of an organic acid, more preferably a divalent metal salt of an organic acid.

Non-limiting examples of the organic acid constituting the divalent metal salt of an organic acid include fatty acids (fatty carboxylic acids), aromatic carboxylic acids, oxocarboxylic acids, and other organic acids.

Examples of the fatty acids (fatty carboxylic acids) include the following compounds.
formic acid [methanoic acid]
acetic acid [ethanoic acid]
propionic acid [propanoic acid]
butyric acid [butanoic acid]
isobutyric acid
valeric acid [pentanoic acid]
isovaleric acid
caproic acid [hexanoic acid]
enanthic acid (heptylic acid) [heptanoic acid]
caprylic acid [octanoic acid]
pelargonic acid [nonanoic acid]
capric acid [decanoic acid]
lauric acid [dodecanoic acid]
myristic acid [tetradecanoic acid]
pentadecylic acid [pentadecanoic acid]
palmitic acid (cetanoic acid) [hexadecanoic acid]
margarinic acid [heptadecanoic acid]
stearic acid [octadecanoic acid]
oleic acid
linoleic acid
linolenic acid
tuberculostearic acid [nonadecanoic acid]
arachidic acid [eicosanoic acid]
arachidonic acid
eicosapentaenoic acid
behenic acid [docosanoic acid]
docosahexaenoic acid
lignoceric acid [tetracosanoic acid]
cerotic acid [hexacosanoic acid]
montanic acid [octacosanoic acid]
melissic acid [triacontanoic acid]

Examples of the aromatic carboxylic acids include the following compounds.
salicylic acid [hydroxybenzoic acid]
gallic acid (trihydroxybenzoic acid)
benzoic acid [benzenecarboxylic acid]
phthalic acid
cinnamic acid (β-phenylacrylic acid)
mellitic acid (graphitic acid) [benzenehexacarboxylic acid]

Examples of the oxocarboxylic acids include the following compound.
pyruvic acid (oxopropionic acid, α-ketopropionic acid, pyroracemic acid)

Examples of other organic acids include the following compounds.
oxalic acid [ethanedioic acid]
lactic acid (α-hydroxypropanoic acid)
tartaric acid
maleic acid
fumaric acid (allomaleic acid, boletic acid, lichenic acid)
malonic acid [propanedioic acid]
succinic acid
malic acid (hydroxysuccinic acid)
citric acid
aconitic acid
glutaric acid
adipic acid [hexanedioic acid]
amino acids
L-ascorbic acid (vitamin C)

Preferred among the organic acids are formic acid, acetic acid, and propionic acid in consideration of the solubility in an aqueous solution of the salt in the hydrogel and the solubility curve. For example, in the range of 0° C. to 100° C., calcium formate exhibits, for its relationship with temperature, a relatively modestly positive solubility curve (the solubility increases when the temperature rises). In contrast, calcium acetate exhibits, for its relationship with temperature, a negative solubility curve in the range of 0° C. to approximately 60° C. and exhibits a relatively modestly positive solubility curve in the range of approximately 50° C. to approximately 85° C. Calcium propionate exhibits, for its relationship with temperature, a negative solubility curve in the range of 0° C. to approximately 50° C. and a positive solubility curve in the range of approximately 50° C. to 100° C.

The divalent metal constituting the divalent metal salt of an organic acid is not limited and is desirably, for example, an alkaline-earth metal. Examples of the alkaline-earth metal include calcium (Ca), magnesium (Mg), strontium (Sr), and barium (Ba).

To better achieve the advantageous effect, the divalent metal salt of an organic acid is desirably Ca formate, Ca acetate, Ca propionate, Mg formate, Mg acetate, Mg propionate, or the like. The LCST of the hydrogel can be varied by the type of the divalent metal salt of an organic acid used.

The total metal concentration in the temperature-responsive material A can be measured by inductively coupled plasma atomic emission analysis (ICP). The metal ion concentration can be determined by incinerating a known volume of the temperature-responsive material A (for example, at approximately 1,000° C.) to remove the organic component, dissolving the residue in a known volume of water, and analyzing the aqueous solution by ICP. In the case where the temperature-responsive material A includes a divalent metal salt of an organic acid, the concentration of free metals not forming the organic acid salt in the temperature-responsive material A can be measured using a metal ion electrode, for example. In the case where a metal ion forming the organic acid salt and a free metal ion are present in the temperature-responsive material A, they can be discriminated from each other using this method.

In the case where the temperature-responsive material A includes a divalent metal salt of an organic acid, the concentration of the divalent metal salt of an organic acid in the temperature-responsive material A can be appropriately designed in consideration of the physical properties required of the temperature-responsive hydrogel and the amount of carboxyl groups. For example, the concentration of an aqueous metal salt solution with which the polymer is impregnated is in the range of 50 mM to the saturation concentration, preferably from 50 to 500 mM. The term “saturation concentration” refers to the saturation amount (equal equivalent) relative to the amount of carboxyl groups in the polymer. The LCST of the hydrogel can be varied by controlling the concentration of the metal salt in the polymer. The concentration of the metal in the polymer tends to be higher than the metal concentration of the aqueous metal salt solution with which the polymer is impregnated and varies with conditions such as the concentration of carboxyl groups in the polymer and the concentration of the metal salt in the aqueous solution. For example, the concentration of the metal may be, for example, approximately 1.1 to 2.0 times higher or typically approximately 1.2 to 1.5 times higher than the metal concentration of the aqueous metal salt solution. In the case where the divalent metal is calcium, the concentration of the divalent metal in the polymer is in the range of approximately 1 to approximately 100 mg based on 1 g of the polymer (gel). The concentration is more typically in the range of approximately 10 to approximately 70 mg, still more typically in the range of approximately 15 to approximately 50 mg.

The temperature-responsive material A (hydrogel) containing a carboxyl group-containing polymer and a metal salt is a gel containing water or an aqueous solution and a polymer as main constituents. Whether or not the polymer will form a hydrogel can be determined mainly by the length of the polymer (in other words, the concentration of the polymerization initiator). At the same polymer mass, a higher polymerization initiator concentration increases the tendency of gel formation. From this point of view, for example, when the monomer is acrylic acid, gel formation tends to occur at 3 M or higher when the polymerization initiator concentration is 0.1 mol % and at 2 M or higher when the polymerization initiator concentration is 0.01 mol, which is about the same when the monomer is methacrylic acid. The polymerization initiator concentration can be appropriately selected in the range in which hydrogel formation occurs, depending on the type of the polymerization initiator and the type of the monomer.

The temperature-responsive material A (hydrogel) has a low critical solution temperature (LCST). The LCST is the lower critical solution temperature at which the hydrogel develops turbidity due to phase separation and is an indicator of the phase separation temperature. For example, whether or not having a LCST can be assessed by measuring the turbidity (transmittance) using an ultraviolet-visible-near infrared spectrophotometer, or alternatively by measuring the endo-/exothermic peak using a differential scanning calorimeter or by measuring the temperature dependence of the dynamic modulus of elasticity using a rheometer (viscoelastic measurement instrument). The LCST of the temperature-responsive material A (hydrogel) varies depending on the composition of the polymer, the type and concentration of the metal salt, and the like. For example, the LCST is within the range of 10° C. to 80° C., preferably within the range of 25° C. to 45° C.

The temperature-responsive material A (hydrogel) is transparent at a temperature below the LCST, while it is turbid above the LCST. The term “transparent” in the present disclosure refers to a transmittance of 85% or higher at a wavelength of 550 nm. The term “turbid” refers a transmittance of 30% or lower at a wavelength of 550 nm.

For example, the temperature-responsive material A (hydrogel) can be produced by immersing a carboxyl group-containing polymer in the aqueous metal salt solution.

The immersion of the polymer in the aqueous metal salt solution can be performed at room temperature, for example, in the range of 4° C. to 30° C. In consideration of the LCST of the temperature responsive hydrogel to be obtained, the immersion may be performed at a temperature higher or lower than the LCST.

The metal salt concentration of the aqueous metal salt solution can be appropriately determined in consideration of the types of the polymer and the metal salt and the desired LCST. For example, the metal salt concentration is in the range of 50 mM to the saturation concentration. For example, the temperature-responsive hydrogel can be obtained by immersing a polymer in an aqueous metal salt solution having a metal salt concentration from 50 mM to the saturation concentration until reaching an approximate equilibrium. With regard to the immersion time for a chemically cross-linked gel, an approximate equilibrium is reached in about 1 to 72 hours. In the case of a physically cross-linked gel, an approximate equilibrium is reached in two to seven days. Immersion until reaching equilibrium may be unnecessary as long as the desired physical properties are obtained.

To better achieve the advantageous effect, the temperature-responsive material A is preferably a material including at least partially a foam structure. The temperature-responsive material A including at least partially a foam structure may partially or entirely include the foam structure. When the temperature-responsive material A is a material including at least partially a foam structure, it can provide a space for swelling of a void where water has been originally present. This can prevent an increase in the volume due to the swelling of the temperature-responsive material A during water absorption, so that the rubber composition when dry may have an improved hardness.

The material including at least partially a foam structure can be obtained by further processing the hydrogel to have a foam structure. The material is obtained by foaming the hydrogel, and it includes at least partially a foam structure with a large number of air bubbles. The hydrogel may be processed to have a foam structure by any method that can provide a material including at least partially a foam structure. The hydrogel may be foamed by a known method. Examples of the method include a method in which the temperature-responsive material A (hydrogel) is warmed, then frozen by rapid (for example, within one hour, preferably within 30 minutes, more preferably within 10 minutes, particularly preferably within 5 minutes) cooling with liquid nitrogen or the like, and freeze-dried.

The warming may be performed under any conditions that cause phase separation in the temperature-responsive material A (hydrogel). For example, the warming temperature is preferably 60° C. or higher, more preferably 80° C. or higher, while it is preferably 120° C. or lower, more preferably 100° C. or lower. The warming time is preferably one minute or longer, preferably five minutes or longer, while it is preferably 24 hours or shorter, more preferably 10 hours or shorter, still more preferably 1 hour or shorter.

The drying time in the freeze-drying is not limited. For example, the drying time is preferably one hour or longer, more preferably five hours or longer, still more preferably 10 hours or longer, particularly preferably 24 hours or longer, while it is preferably 72 hours or shorter, more preferably 48 hours or shorter, still more preferably 30 hours or shorter.

Another exemplary method to allow the hydrogel to have a foam structure includes foaming the hydrogel by adding, to the hydrogel, an inorganic foaming agent such as sodium bicarbonate or ammonium carbonate or an organic foaming agent such as azodicarbonamide, dinitrosopentamethylenetetramine, or p,p′-oxybis(benzenesulfonyl hydrazide).

The amount of the temperature-responsive material A per 100 parts by mass of the rubber component in the rubber composition is preferably 5 parts by mass or more, more preferably 10 parts by mass or more, still more preferably 15 parts by mass or more, particularly preferably 20 parts by mass or more. The upper limit is preferably 100 parts by mass or less, more preferably 60 parts by mass or less, still more preferably 50 parts by mass or less, particularly preferably 40 parts by mass or less. When the amount is within the range indicated above, the advantageous effect tends to be better achieved.

In the present disclosure, the amount of the temperature-responsive material A means the amount of a temperature-responsive hydrogel (gel containing water or an aqueous solution and a polymer as main constituents) containing a carboxyl group-containing polymer and a metal salt. The amount includes the amount of water contained in the temperature-responsive material (temperature-responsive hydrogel) as well as the amounts of the carboxyl group-containing polymer and the metal salt.

To better achieve the advantageous effect, the rubber composition desirably contains at least one of a water-soluble material B or a water-absorbent material B.

In the present disclosure, at least one of a water-soluble material B or a water-absorbent material B is different from the temperature-responsive material A containing a carboxyl group-containing polymer and a metal salt. Specifically, for example, when the rubber composition contains a temperature-responsive hydrogel including polyacrylic acid and calcium acetate as the temperature-responsive material A and further contains calcium acetate monohydrate as at least one of a water-soluble material B or a water-absorbent material B, the calcium acetate in the temperature-responsive material A does not correspond to at least one of a water-soluble material B or a water-absorbent material B, while the separately added calcium acetate monohydrate corresponds to at least one of a water-soluble material B or a water-absorbent material B.

The water-soluble material B (hereinafter, also referred to simply as water-soluble material) in at least one of a water-soluble material B or a water-absorbent material B is not limited and may be a known water-soluble material. For example, a material having a solubility in water at 20° C. of 25 g/100 g of water is usable. To better achieve the advantageous effect, the metal salt or its hydrate is preferred, and the divalent metal salt of an organic acid or its hydrate is more preferred. Examples of the organic acid and the divalent metal constituting the divalent metal salt of an organic acid include the compounds described above. A hydrate capable of forming a metal salt, such as a monohydrate or a dihydrate, can be appropriately used as the hydrate.

To better achieve the advantageous effect, preferred among the water-soluble materials are alkaline-earth metal salts of organic acids and their hydrates, and more preferred are Ca formate, Ca acetate, Ca propionate, Mg formate, Mg acetate, and Mg propionate, and their hydrates.

The water-absorbent material B (hereinafter, also referred to simply as water-absorbent material) in at least one of a water-soluble material B or a water-absorbent material B is not limited and may be a known water-absorbent material. For example, a material having a water absorption rate of 5% or higher as measured by the following method is usable.

(Measurement method)

The weights before and after immersion in water at 20° C. for 24 hours are measured, and the water absorption rate is calculated using the following expression.

$$Water absorption rate ( \% ) = ( weight after immersion - weight before \text{immersion)/weight} after immersion \times 100$$

Examples of the water-absorbent material include heteroatom-containing materials (fibers, elastomers, resins).

The term “heteroatom” refers to an atom other than a carbon atom and a hydrogen atom, and may be any heteroatom capable of forming a reversible molecular binding with water, such as a hydrogen bond or an ionic bond. The heteroatom is preferably at least one atom selected from the group consisting of an oxygen atom, a nitrogen atom, a silicon atom, a sulfur atom, a phosphorus atom, and halogen atoms, more preferably an oxygen atom, a nitrogen atom, or a silicon atom, still more preferably an oxygen atom.

Examples of structures or groups containing an oxygen atom include ether groups, esters, carboxy groups, carbonyl groups, alkoxy groups, and hydroxy groups. Ether groups are preferred among these, with oxyalkylene groups being more preferred.

Examples of structures or groups containing a nitrogen atom include amino groups (primary amino groups, secondary amino groups, and tertiary amino groups), amide groups, nitrile groups, and nitro groups. Amino groups are preferred among these, with tertiary amino groups being more preferred.

Examples of structures or groups containing a silicon atom include silyl groups, alkoxysilyl groups, and silanol groups. Silyl groups are preferred among these, with alkoxysilyl groups being more preferred.

Examples of structures or groups containing a sulfur atom include sulfide groups, sulfuric acid groups, sulfates, and sulfo groups.

Examples of structures or groups containing a phosphorus atom include phosphoric acid groups and phosphates.

Examples of structures or groups containing halogen atoms include halogeno groups such as a fluoro group, a chloro group, a bromo group, and an iodo group.

Examples of water-absorbent fibers include cellulose fibers which contain hydroxy groups.

Cellulose microfibrils are preferred among the cellulose fibers. Any cellulose microfibril derived from a naturally-occurring material may be used. Examples include those derived from: resource biomass such as fruits, grains, and root vegetables; wood, bamboo, hemp, jute, and kenaf, and pulp, paper, or cloth produced therefrom; waste biomass such as agricultural waste, food waste, and sewage sludge; unused biomass such as rice straw, wheat straw, and thinnings; and celluloses produced by ascidians, acetic acid bacteria, or other organisms. Each of these may be used alone or in combinations of two or more.

Examples of water-absorbent elastomers include oxyalkylene group-containing elastomers. Examples of the elastomers include epoxide/allyl glycidyl ether copolymers, amine/allyl glycidyl ether copolymers, and silyl/allyl glycidyl ether copolymers. Each of these may be used alone or in combinations of two or more.

Examples of water-absorbent resins include polyvinyl alcohol, polyurethane, polyvinyl acetate, epoxy resins, cellulose resins, polyethylene glycol, and sodium polyacrylate. Each of these may be used alone or in combinations of two or more.

The amount of at least one of a water-soluble material B or a water-absorbent material B (total amount of the water-soluble material and the water-absorbent material) per 100 parts by mass of the rubber component in the rubber composition is preferably 5 parts by mass or more, more preferably 10 parts by mass or more, still more preferably 15 parts by mass or more, particularly preferably 20 parts by mass or more. The upper limit is preferably 100 parts by mass or less, more preferably 60 parts by mass or less, still more preferably 50 parts by mass or less, particularly preferably 40 parts by mass or less, most preferably 30 parts by mass or less. When the amount is within the range indicated above, the advantageous effect tends to be better achieved. In the case where the rubber composition contains the water-soluble material and/or the water-absorbent material, the amount is desirably within the range indicated above.

In the present disclosure, the amount of at least one of a water-soluble material B or a water-absorbent material B refers to a total amount of the water-soluble material and the water-absorbent material. When the water-soluble material and the water-absorbent material are each a hydrate, the total amount includes the amount of the hydrate(s).

From the standpoint of properties such as cracking resistance and ozone resistance, the rubber composition preferably contains an antioxidant.

Non-limiting examples of the antioxidant include naphthylamine antioxidants such as phenyl-α-naphthylamine; diphenylamine antioxidants such as octylated diphenylamine and 4,4′-bis(α,α′-dimethylbenzyl)diphenylamine; p-phenylenediamine antioxidants such as N-isopropyl-N′-phenyl-p-phenylenediamine, N-(1,3-dimethylbutyl)-N′-phenyl-p-phenylenediamine, and N,N′-di-2-naphthyl-p-phenylenediamine; quinoline antioxidants such as polymerized 2,2,4-trimethyl-1,2-dihydroquinoline; monophenolic antioxidants such as 2,6-di-t-butyl-4-methylphenol and styrenated phenol; and bis-, tris-, or polyphenolic antioxidants such as tetrakis [methylene-3-(3′,5′-di-t-butyl-4′-hydroxyphenyl) propionate]methane. Preferred among these are p-phenylenediamine antioxidants and quinoline antioxidants, and N-(1,3-dimethylbutyl)-N′-phenyl-p-phenylenediamine or polymerized 2,2,4-trimethyl-1,2-dihydroquinoline is more preferred. Usable commercial products may be available from Seiko Chemical Co., Ltd., Sumitomo Chemical Co., Ltd., Ouchi Shinko Chemical Industrial Co., Ltd., Flexsys, etc.

The amount of antioxidants per 100 parts by mass of the rubber component in the rubber composition is preferably 0.5 parts by mass or more, more preferably 2.0 parts by mass or more. The amount is preferably 7.0 parts by mass or less, more preferably 4.0 parts by mass or less.

The rubber composition may contain stearic acid.

The amount of stearic acid per 100 parts by mass of the rubber component in the rubber composition is preferably 0.5 to 10 parts by mass or more, more preferably 1.5 to 5 parts by mass.

The stearic acid may be conventional one. Usable commercial products may be available from NOF Corporation, Kao Corporation, FUJIFILM Wako Pure Chemical Corporation, Chiba Fatty Acid Co., Ltd., etc.

The rubber composition may contain zinc oxide.

The amount of zinc oxide per 100 parts by mass of the rubber component in the rubber composition is preferably 0.5 to 10 parts by mass, more preferably 2 to 6 parts by mass.

The zinc oxide may be conventional one. Usable commercial products may be available from Mitsui Mining & Smelting Co., Ltd., Toho Zinc Co., Ltd., HakusuiTech Co., Ltd., Seido Chemical Industry Co., Ltd., Sakai Chemical Industry Co., Ltd., etc.

The rubber composition may contain wax.

The amount of wax per 100 parts by mass of the rubber component in the rubber composition is preferably 0.5 to 10 parts by mass, more preferably 2 to 5 parts by mass.

Non-limiting examples of the wax include petroleum waxes and natural waxes and also include synthetic waxes prepared by purifying or chemically treating a plurality of waxes. Each of these waxes may be used alone or in combinations of two or more.

Examples of the petroleum waxes include paraffin waxes and microcrystalline waxes. The natural waxes may be any wax derived from non-petroleum resources, and examples include plant waxes such as candelilla wax, carnauba wax, Japan wax, rice wax, and jojoba wax; animal waxes such as beeswax, lanolin, and spermaceti; mineral waxes such as ozokerite, ceresin, and petrolatum; and purified products of these waxes. Usable commercial products may be available from Ouchi Shinko Chemical Industrial Co., Ltd., Nippon Seiro Co., Ltd., Seiko Chemical Co., Ltd., etc.

The rubber composition may contain a vulcanization accelerator.

The amount of vulcanization accelerators per 100 parts by mass of the rubber component in the rubber composition is usually 0.3 to 10 parts by mass, preferably 0.5 to 4 parts by mass.

Any type of vulcanization accelerator may be used, including usually used ones. Examples of the vulcanization accelerator include thiazole vulcanization accelerators such as 2-mercaptobenzothiazole, di-2-benzothiazolyl disulfide, and N-cyclohexyl-2-benzothiazylsulfenamide; thiuram vulcanization accelerators such as tetramethylthiuram disulfide (TMTD), tetrabenzylthiuram disulfide (TBzTD), and tetrakis(2-ethylhexyl) thiuram disulfide (TOT-N); sulfenamide vulcanization accelerators such as N-cyclohexyl-2-benzothiazole sulfenamide, N-t-butyl-2-benzothiazolylsulfenamide, N-oxyethylene-2-benzothiazole sulfenamide, and N,N′-diisopropyl-2-benzothiazole sulfenamide; and guanidine vulcanization accelerators such as diphenylguanidine, diorthotolylguanidine, and orthotolylbiguanidine. Each of these may be used alone or in combinations of two or more. Sulfenamide vulcanization accelerators and guanidine vulcanization accelerators are preferred among these.

The rubber composition may contain other appropriate additives usually used in the application field, such as a release agent or a pigment, in addition to the above-described components. The amount of each additive per 100 parts by mass of the rubber component in the rubber composition is preferably 0.5 to 10 parts by mass, more preferably 2 to 5 parts by mass.

To better achieve the advantageous effect, in the rubber composition, a ratio of the amount of at least one of a water-soluble material B or a water-absorbent material B to the amount of the cross-linking agent (amount of at least one of a water-soluble material B or a water-absorbent amount of material B/amount of cross-linking agent) is desirably 2.0 to 40.0. The lower limit is preferably 6.7 or higher, more preferably 10.0 or higher, still more preferably 13.3 or higher, particularly preferably 16.7 or higher, most preferably 20.0 or higher. The upper limit is preferably 50.0 or lower, more preferably 40.0 or lower, still more preferably 30.0 or lower.

The rubber composition may be prepared by known methods. For example, it may be prepared by kneading the components in a rubber kneading machine such as an open roll mill or a Banbury mixer, optionally followed by cross-linking. The kneading conditions include a kneading temperature of usually 50° C. to 200° C., preferably 80° C. to 190° C., and a kneading time of usually 30 seconds to 30 minutes, preferably 1 minute to 30 minutes.

To better achieve the advantageous effect, the rubber composition desirably has a dynamic modulus of elasticity when immersed in water at 0° C. (E*w at 0° C.) and a dynamic modulus of elasticity when dry at 0° C. (E*d at 0° C.) which satisfy the following formula (1):

$$E * w at 0 ° C . / E * d at 0 ° C . \leq 0.7 . \qquad ( 1 )$$

The ratio “E*w at 0° C./E*d at 0° C.” is preferably 0.56 or lower, more preferably 0.55 or lower, still more preferably 0.54 or lower, further preferably 0.53 or lower, further preferably 0.51 or lower, further preferably 0.49 or lower, further preferably 0.45 or lower, further preferably 0.44 or lower, further preferably 0.42 or lower, further preferably 0.40 or lower, further preferably 0.39 or lower, further preferably 0.33 or lower, further preferably 0.31 or lower, further preferably 0.30 or lower, further preferably 0.28 or lower, particularly preferably 0.27 or lower. The lower limit is not limited and is preferably 0.01 or higher, more preferably 0.05 or higher, still more preferably 0.10 or higher.

To better achieve the advantageous effect, the rubber composition desirably has a dynamic modulus of elasticity when immersed in water at 0° C. (E*w at 0° C.) and a dynamic modulus of elasticity when immersed in water at 30° C. (E*w at 30° C.) which satisfy the following formula (2):

$$E * w at 30 ° C . / E * d at 0 ° C . \geq 0.8 . \qquad ( 2 )$$

The ratio “E*w at 30° C./E*w at 0° C.” is preferably 0.83 or higher, more preferably 0.85 or higher, still more preferably 0.87 or higher, further preferably 0.88 or higher, further preferably 0.89 or higher, further preferably 0.90 or higher, further preferably 0.95 or higher, further preferably 0.98 or higher, further preferably 1.04 or higher, further preferably 1.05 or higher, further preferably 1.06 or higher, further preferably 1.08 or higher, particularly preferably 1.10 or higher, particularly preferably 1.20 or higher, particularly preferably 1.23 or higher, particularly preferably 1.24 or higher, particularly preferably 1.25 or higher, most preferably 1.29 or higher. The upper limit is not limited and is preferably 3.00 or lower, more preferably 2.00 or lower, still more preferably 1.50 or lower.

The reason for the advantageous effect of the elastomer composition satisfying the formulas (1) and (2) is not completely clear, but it is believed to be as follows.

The formula “(1) E*w at 0° C./E*d at 0° C.≤0.70” means that the modulus of elasticity when immersed in water is relatively largely lower than that when dry at low temperatures. The formula “(2) E*w at 30° C./E*w at 0° C.≥0.80” means that a practical modulus of elasticity when immersed in water is maintained even at high temperatures as compared to that at low temperatures. As described above, the rubber composition changes the behavior relating to the modulus of elasticity along with temperature changes. Thus, it can change tire performance in response to temperature changes.

In this case, the problem (aim) of changing tire performance in response to temperature changes is solved by the rubber composition that contains predetermined amounts of a rubber component including at least one selected from the group consisting of polyisoprene rubber, polybutadiene rubber, and styrene-butadiene rubber, a cross-linking agent, carbon black, a plasticizer, and a temperature-responsive material A containing a carboxyl group-containing polymer and a metal salt and also satisfies the parameters of the formulas (1) and (2). In other words, the parameters do not define the problem (aim). The problem herein is to change tire performance in response to temperature changes. In order to solve the problem, a rubber composition has been formulated to contain the predetermined amounts of the materials and satisfy the parameters of the formulas (1) and (2).

To better achieve the advantageous effect, the rubber composition desirably has a dynamic modulus of elasticity when immersed in water at 0° C. (E*w at 0° C.) satisfying the following formula:

$$E * w at 0 ° C . \leq 8. MPa .$$

The value of “E*w at 0° C.” is preferably 5.0 MPa or less, more preferably 4.8 MPa or less, more preferably 4.6 MPa or less, still more preferably 4.5 MPa or less, further preferably 4.2 MPa or less, further preferably 4.0 MPa or less, further preferably 3.8 MPa or less, further preferably 3.7 MPa or less, further preferably 3.5 MPa or less, further preferably 3.3 MPa or less, particularly preferably 3.2 MPa or less, most preferably 3.1 MPa or less. The lower limit is not limited and is preferably 1.0 MPa or more, more preferably 1.3 MPa or more, still more preferably 1.5 MPa or more, further preferably 2.7 MPa or more, further preferably 2.8 MPa or more, further preferably 3.0 MPa or more.

To better achieve the advantageous effect, the rubber composition desirably has a dynamic modulus of elasticity when immersed in water at 30° C. (E*w at 30° C.) satisfying the following formula:

$$E * w at 30 ° C . \geq 3. MPa .$$

The value of “E*w at 30° C.” is preferably 3.3 MPa or more, more preferably 3.4 MPa or more, still more preferably 3.5 MPa or more, further preferably 3.6 MPa or more, further preferably 3.7 MPa or more, further preferably 3.8 MPa or more, particularly preferably 3.9 MPa or more, furthermore preferably 4.0 MPa or more, still furthermore preferably 4.1 MPa or more, even furthermore preferably 4.3 MPa or more, most preferably 4.5 MPa or more. The upper limit is not limited and is preferably 10.0 MPa or less, more preferably 8.0 MPa or less, still more preferably 7.0 MPa or less, particularly preferably 6.0 MPa or less.

To better achieve the advantageous effect, the rubber composition desirably has a dynamic modulus of elasticity when dry at 0° C. (E*d at 0° C.) satisfying the following formula:

$$E * d at 0 ° C . \geq 5. MPa .$$

The value of “E*d at 0° C.” is preferably 6.0 MPa or more, more preferably 6.9 MPa or more, still more preferably 7.0 MPa or more, further preferably 7.8 MPa or more, further preferably 8.0 MPa or more, further preferably 8.2 MPa or more, further preferably 8.3 MPa or more, further preferably 8.4 MPa or more, further preferably 8.5 MPa or more, further preferably 9.0 MPa or more, further preferably 10.0 MPa or more, further preferably 10.5 MPa or more, further preferably 10.7 MPa or more, further preferably 11.0 MPa or more, particularly preferably 11.6 MPa or more, most preferably 12.0 MPa or more, furthermore preferably 12.3 MPa or more. The upper limit is not limited and is preferably 20.0 MPa or less, more preferably 18.0 MPa or less, still more preferably 16.0 MPa or less, further preferably 15.0 MPa or less.

In the present disclosure, the dynamic modulus of elasticity E* is measured by the method described in EXAMPLES.

In the present disclosure, the dynamic modulus of elasticity E* of the rubber composition refers to the dynamic modulus of elasticity E* of the vulcanized (cross-linked) rubber composition.

In the present disclosure, the dynamic modulus of elasticity E* when dry refers to the dynamic modulus of elasticity of the vulcanized rubber composition when it is dry; specifically, the dynamic modulus of elasticity of the vulcanized rubber composition which has been dried by the method described in EXAMPLES.

In the present disclosure, the dynamic modulus of elasticity E* when immersed in water refers to the dynamic modulus of elasticity of the rubber composition after it is immersed in water; specifically, the dynamic modulus of elasticity of the vulcanized rubber composition after it is immersed in water by the method described in EXAMPLES.

In the present disclosure, the dynamic modulus of elasticity E* of the vulcanized rubber composition is determined by measuring the dynamic modulus of elasticity E* of a test vulcanized rubber sheet at a strain of 2% and a frequency of 10 Hz using ARES (a rheometer available from TA instruments).

Next, production guidelines to satisfy the formulas “(1) E*w at 0° C./Ed at 0° C.≤0.70”, “(2) E*w at 30° C./E*w at 0° C.≥0.80”, “E*w at 0° C.≤8.0 MPa”, “E*w at 30° C.≥3.0 MPa”, and “E*d at 0° C.≥5.0 MPa” are explained.

The formula “(1) E*w at 0° C./E*d at 0° C.≤0.70” means that the modulus of elasticity when immersed in water is relatively largely lower than that when dry at low temperatures. The formula “(2) E*w at 30° C./E*w at 0° C.≥0.80” means that a practical modulus of elasticity when immersed in water is maintained even at high temperatures as compared to that at low temperatures. For example, a rubber composition satisfying the formulas (1) and (2) can be produced by incorporating a temperature-responsive material A containing a carboxyl group-containing polymer and a metal salt in the rubber composition. Production of such a rubber composition can be facilitated by incorporating a material including at least partially a foam structure as the temperature-responsive material A or additionally incorporating at least one of a water-soluble material B or a water-absorbent material B in the rubber composition.

The formula “E*w at 0° C.≤8.0 MPa” means an improvement in grip performance on an icy road. For example, a rubber composition satisfying the formula can be produced by incorporating the temperature-responsive material A in the rubber composition. Production of such a rubber composition can be facilitated by incorporating a material including at least partially a foam structure as the temperature-responsive material A or additionally incorporating the material B in the rubber composition.

The formula “E*d at 0° C.≥5.0 MPa” means an improvement in grip performance on a dry road. For example, a rubber composition satisfying the formula can be produced by incorporating the temperature-responsive material A in the rubber composition. Production of such a rubber composition can be facilitated by incorporating a material including at least partially a foam structure as the temperature-responsive material A or additionally incorporating the material B in the rubber composition.

The dynamic modulus of elasticity E* (absolute value) when dry can be controlled by the types and amounts of chemicals (in particular, rubber components, fillers, plasticizers) incorporated in the composition. For example, the dynamic modulus of elasticity E* when dry tends to decrease when the amount of plasticizers is increased, the dynamic modulus of elasticity E* when dry tends to increase when the amount of fillers is increased, and the dynamic modulus of elasticity E* when dry tends to decrease when the amount of sulfur is reduced. The dynamic modulus of elasticity E* when dry can also be controlled by varying the amounts of sulfur and vulcanization accelerators. Specifically, the dynamic modulus of elasticity E* when dry tends to increase when the amount of sulfur is increased, and the dynamic modulus of elasticity E* when dry tends to increase when the amount of vulcanization accelerators is increased.

Specifically, the formulas “(1) E*w at 0° C./E*d at 0° C.≤0.70”, “(2) E*w at 30° C./E*w at 0° C.≥0.80”, “E*w at 0° C.≤8.0 MPa”, “E*w at 30° C.≥3.0 MPa”, and “E*d at 0° C.≥5.0 MPa” can be satisfied by controlling the dynamic modulus of elasticity E* when dry in the desired range and also incorporating a temperature-responsive material A containing a carboxyl group-containing polymer and a metal salt in the rubber composition, while optionally using a material including at least partially a foam structure as the temperature-responsive material A or further incorporating at least one of a water-soluble material B or a water-absorbent material B in the rubber composition.

The rubber composition may be used (as a tire rubber composition) in tire components such as treads, sidewalls, base treads, undertreads, shoulders, clinches, bead apexes, breaker cushion rubbers, rubbers for carcass cord topping, insulations, chafers, and innerliners, and side reinforcement layers of run-flat tires. The rubber composition is suitable for treads.

The tire of the present disclosure can be produced using the rubber composition by a usual method.

For example, a rubber composition containing various materials before vulcanization is extruded and processed into a tread shape or the like and then molded with other tire components on a tire building machine by an usual method to form an unvulcanized tire, and the unvulcanized tire is heated and pressurized in a vulcanizer, whereby a tire is obtained.

The tire may be suitably used as a tire for passenger vehicles, large passenger vehicles, large SUVs, trucks and buses, or two-wheeled vehicles, or as a racing tire, a winter tire (studless winter tire, snow tire, studded tire), an all-season tire, a run-flat tire, an aircraft tire, a mining tire, etc. The tire is suitably used as a winter tire (studless winter tire, snow tire, studded tire) or an all-season tire among others.

### EXAMPLES

Examples (working examples) which are considered preferable to implement the present disclosure are described below. Yet, the scope of the disclosure is not limited to the examples.

The chemicals used in the following examples and comparative examples are listed below.
NR: TSR20
BR: BR150B (cis content: 98% by mass) available from Ube Industries, Ltd.
SBR: Nipol SBR1502 (styrene content: 23.5% by mass) available from Zeon Corporation
Carbon black: Seast N220 (N2SA: 111 m²/g) available from Mitsubishi Chemical Corporation
Silica: ULTRASIL VN3 (N2SA: 175 m²/g) available from Evonik Degussa
Silane coupling agent: Si266 (bis(3-triethoxysilylpropyl)disulfide) available from Evonik Degussa
Oil: Diana Process NH-70S available from Idemitsu Kosan Co., Ltd.
Plasticizer A: RICON 150 (liquid polybutadiene polymer) available from Sartomer
Temperature-responsive material A-1: Production Example 1 (polyacrylic acid/calcium acetate gel)
Temperature-responsive material A-2: Production Example 2 (foamed polyacrylic acid/calcium acetate gel)
Temperature-responsive material A-3: Production Example 3 (polyacrylic acid/calcium propionate gel)
Temperature-responsive material A-4: Production Example 4 (foamed polyacrylic acid/calcium propionate gel)
Water-soluble material B: calcium acetate monohydrate (solubility in water at 20° C.: 34.7 g/100 g of water) available from WAKO
Water-absorbent material B: biomass nanofiber (Product name “BiNFi-s cellulose”, microfibrillated cellulose fiber, water absorption rate: 10%) available from SUGINO MACHINE LIMITED
Antioxidant: NOCRAC 6C available from Ouchi Shinko Chemical Industrial Co., Ltd.
Stearic acid: stearic acid available from NOF Corporation
Zinc oxide: zinc oxide #2 available from Mitsui Mining & Smelting Co., Ltd.
Sulfur: powdered sulfur available from Tsurumi Chemical Industry Co., Ltd.
Cross-linking agent A: TACKIROL V200 (alkylphenol-sulfur chloride condensate) available from Taoka Chemical Co., Ltd.
Vulcanization accelerator CZ: NOCCELER CZ-G available from Ouchi Shinko Chemical Industrial Co., Ltd.
Vulcanization accelerator DPG: NOCCELER D available from Ouchi Shinko Chemical Industrial Co., Ltd.

### Production Example 1

With reference to Advanced Materials 2020, 32, 1905878, a temperature-responsive material A-1 was produced by the following method.

A precursor aqueous solution was prepared by dissolving, in ultrapure water, 1.0 M acrylic acid (AAc), potassium peroxodisulfate as an initiator in an amount of 1.0 mol % relative to the monomer concentration, and N,N′-methylenebisacrylamide (MbAAd) as a cross-linking agent in an amount of 1.0 mol % relative to the monomer concentration.

Here, when the concentration of the cross-linking agent is 0 mol %, a physically cross-linked gel can be obtained. When the cross-linking agent is added, a chemically cross-linked gel can be obtained.

The solution was poured into a mold form with a freely-selected shape and heated in air at 60° C. for six hours to form a gel.

The polymerized gel or a non-flowable highly viscous substance was immersed in a sufficient volume of a 1,000 mM solution of calcium acetate in ultrapure water until reaching equilibrium. Thus, a temperature-responsive material A-1 was obtained.

### Production Example 2

The temperature-responsive material A-1 was warmed at 80° C. for five minutes and then frozen in liquid nitrogen. The frozen temperature-responsive material A-1 was freeze-dried for 24 hours using a freeze-dryer (FDU-2110 available from EYELA). Thus, a temperature-responsive material A-2 including a foam structure was obtained.

### Production Example 3

With reference to Advanced Materials 2020, 32, 1905878, a temperature-responsive material A-3 was produced by the following method.

A precursor aqueous solution was prepared by dissolving, in ultrapure water, 1.0 M acrylic acid (AAc), potassium peroxodisulfate as an initiator in an amount of 1.0 mol % relative to the monomer concentration, and N,N′-methylenebisacrylamide (MbAAd) as a cross-linking agent in an amount of 1.0 mol % relative to the monomer concentration.

Here, when the concentration of the cross-linking agent is 0 mol %, a physically cross-linked gel can be obtained. When the cross-linking agent is added, a chemically cross-linked gel can be obtained.

The solution was poured into a mold form with a freely-selected shape and heated in air at 60° C. for six hours to form a gel.

The polymerized gel or a non-flowable highly viscous substance was immersed in a sufficient volume of a 1,000 mM solution of calcium propionate in ultrapure water until reaching equilibrium. Thus, a temperature-responsive material A-3 was obtained.

### Production Example 4

The temperature-responsive material A-3 was warmed at 80° C. for five minutes and then frozen in liquid nitrogen. The frozen temperature-responsive material A-3 was freeze-dried for 24 hours using a freeze-dryer (FDU-2110 available from EYELA). Thus, a temperature-responsive material A-4 including a foam structure was obtained.

### EXAMPLES AND COMPARATIVE EXAMPLES

According to the formulation shown in Table 1, the chemicals other than the sulfur and vulcanization accelerators were kneaded using a 1.7 L Banbury mixer (Kobe Steel, Ltd.) at 150° C. for five minutes to obtain a kneaded mixture. Then, the sulfur and vulcanization accelerator were added to the kneaded mixture, and they were kneaded in an open roll mill at 80° C. for five minutes to obtain an unvulcanized rubber composition.

The unvulcanized rubber composition was press-vulcanized at 170° C. for 12 minutes to prepare a 1 mm-thick vulcanized rubber composition sheet.

Separately, the unvulcanized rubber composition prepared as above was formed into a cap tread shape and assembled with other tire components to build an unvulcanized tire. The unvulcanized tire was vulcanized at 170° C. for 15 minutes to prepare a test tire (size: 195/65R15).

The vulcanized rubber composition and the test tire prepared as above were stored at room temperature in the dark for three months and then subjected to the following evaluations. Table 1 shows the results.

### (Measurement of Dynamic Modulus of Elasticity E*)

The dynamic modulus of elasticity E* of the 1 mm-thick vulcanized rubber composition sheet was measured.

Specifically, the 1 mm-thick vulcanized rubber composition sheet was maintained at a measurement temperature for 10 minutes, and then the dynamic modulus E* (at 0° C. or 30° C.) of the vulcanized rubber composition sheet was measured at a strain of 2% and a frequency of 10 Hz using ARES (a rheometer available from TA Instruments).

Here, the vulcanized rubber composition sheet for measurement was prepared as described below.

The 1 mm-thick vulcanized rubber composition sheet was immersed in water at 25° C. for 10 hours. Then, the sheet was dried under reduced pressure at 80° C. and 1 kPa or lower to a constant weight to obtain a dried vulcanized rubber composition sheet. The temperature of the dried vulcanized rubber composition sheet was returned to 25° C., and the resulting sheet was used as the vulcanized rubber composition sheet for the measurement of the dynamic modulus of elasticity E* when dry.

Separately, the dried vulcanized rubber composition sheet was again immersed in water at 25° C. for 10 hours, and the resulting sheet was used as the vulcanized rubber composition sheet for the measurement of the dynamic modulus of elasticity E* when immersed in water.

### (Ice Grip Performance)

A set of the test tires were mounted on a front-engine, rear-wheel-drive car of 2,000 cc displacement made in Japan. The car was driven on ice to evaluate the ice grip performance. Specifically, evaluation of the ice grip performance was performed by measuring the stopping distance (brake stopping distance on ice) required for the car traveling on ice to stop after the brakes that lock up were applied at 30 km/h. The distance was expressed as an index (ice grip performance index) relative to that of Comparative Example 1 taken as 100. A higher index indicates better braking performance on ice (ice grip performance).

### (Dry Grip Performance)

The test tire was mounted on every wheel of a front-engine, front-wheel-drive car of 2,000 cc displacement made in Japan. The braking distance of the car with an initial speed of 100 km/h on a dry asphalt road was measured. The distance was expressed as an index (dry grip performance index) relative to that of Comparative Example 1 taken as 100. A higher index indicates a shorter braking distance and better dry grip performance.

### (Overall Performance)

A sum of the ice grip performance (index) and the dry grip performance (index) was defined as the overall performance in terms of the ice grip performance and the dry grip performance. The overall performance was evaluated. A higher index indicates better overall performance.

TABLE 1

| | | Example | | | | | | | |
|---|---|---|---|---|---|---|---|---|---|
| | | 1 | 2 | 3 | 4 | 5 | 6 | 7 | 8 |
| Amount | NR | 40 | 40 | 40 | 40 | | 40 | 40 | 40 |
| (parts | BR | 60 | 60 | 60 | 60 | 60 | 60 | 60 | 60 |
| by | SBR | | | | | 40 | | | |
| mass) | Carbon black | 10 | 10 | 10 | 10 | 10 | 10 | 10 | 5 |
| | Silica | 60 | 60 | 60 | 60 | 60 | 60 | 60 | 60 |
| | Silane coupling agent | 5 | 5 | 5 | 5 | 5 | 5 | 5 | 5 |
| | Oil | 25 | 25 | 25 | 25 | 25 | 25 | 25 | 25 |
| | Plasticizer A | | | | | | | | |
| | Temperature-responsive | 10 | 20 | 20 | 20 | 20 | 20 | 20 | 20 |
| | material A-1 | | | | | | | | |
| | Temperature-responsive | | | | | | | | |
| | material A-2 | | | | | | | | |
| | (including foam | | | | | | | | |
| | structure) | | | | | | | | |
| | Temperature-responsive | | | | | | | | |
| | material A-3 | | | | | | | | |
| | Temperature-responsive | | | | | | | | |
| | material A-4 | | | | | | | | |
| | (including foam | | | | | | | | |
| | structure) | | | | | | | | |
| | Water-soluble material B | | | 10 | 20 | 20 | 20 | 20 | 20 |
| | Water-absorbent | | | | | | 10 | | |
| | material B | | | | | | | | |
| | Antioxidant | 2 | 2 | 2 | 2 | 2 | 2 | 2 | 2 |
| | Stearic acid | 1.5 | 1.5 | 1.5 | 1.5 | 1.5 | 1.5 | 1.5 | 1.5 |
| | Zinc oxide | 2 | 2 | 2 | 2 | 2 | 2 | 2 | 2 |
| | Sulfur | 1.5 | 1.5 | 1.5 | 1.5 | 1.5 | 1.5 | 1.2 | 1.5 |
| | Cross-linking agent A | | | | | | | | |
| | Vulcanization accelerator CZ | 2 | 2 | 2 | 2 | 2 | 2 | 2 | 2 |
| | Vulcanization accelerator DPG | 2 | 2 | 2 | 2 | 2 | 2 | 2 | 2 |
| Properties•Evaluation | Amount of at least | 0.0 | 0.0 | 6.7 | 13.3 | 13.3 | 20.0 | 16.7 | 13.3 |
| | one of water-soluble | | | | | | | | |
| | material B or water- | | | | | | | | |
| | absorbent material B/ | | | | | | | | |
| | Amount of cross-linking agent | | | | | | | | |
| | E*w at 0° C. [MPa] | 4.8 | 4.5 | 4.0 | 3.5 | 4.0 | 3.2 | 3.2 | 3.3 |
| | E*d at 0° C. [MPa] | 6.9 | 8.2 | 10.0 | 11.6 | 12.0 | 12.0 | 10.7 | 10.5 |
| | E*w at 30° C. [MPa] | 3.8 | 3.8 | 3.8 | 3.9 | 3.9 | 3.5 | 3.4 | 3.5 |
| | E*w at 0° C./E*d at 0° C. | 0.70 | 0.55 | 0.40 | 0.30 | 0.33 | 0.27 | 0.30 | 0.31 |
| | E*w at 30° C./E*w at 0° C. | 0.80 | 0.85 | 0.95 | 1.10 | 0.98 | 1.08 | 1.06 | 1.05 |
| | (a) Ice grip performance | 103 | 107 | 114 | 120 | 108 | 125 | 123 | 120 |
| | (b) Dry grip performance | 110 | 110 | 108 | 112 | 114 | 96 | 95 | 97 |
| | Overall performance | 213 | 217 | 222 | 232 | 222 | 221 | 218 | 217 |
| | (=(a) + (b)) | | | | | | | | |

| | | Example | | | | | | |
|---|---|---|---|---|---|---|---|---|
| | | 9 | 10 | 11 | 12 | 13 | 14 | 15 |
| Amount | NR | 40 | 40 | 40 | 40 | 40 | 40 | 40 |
| (parts | BR | 60 | 60 | 60 | 60 | 60 | 60 | 60 |
| by | SBR | | | | | | | |
| mass) | Carbon black | 10 | 10 | 10 | 10 | 10 | 10 | 10 |
| | Silica | 60 | 60 | 60 | 60 | 60 | 60 | 60 |
| | Silane coupling agent | 5 | 5 | 5 | 5 | 5 | 5 | 5 |
| | Oil | 40 | 25 | 25 | 25 | 25 | 25 | 25 |
| | Plasticizer A | | | | | | | |
| | Temperature-responsive | 20 | | | 5 | | 20 | 20 |
| | material A-1 | | | | | | | |
| | Temperature-responsive | | 10 | 20 | | | | |
| | material A-2 | | | | | | | |
| | (including foam | | | | | | | |
| | structure) | | | | | | | |
| | Temperature-responsive | | | | | 20 | | |
| | material A-3 | | | | | | | |
| | Temperature-responsive | | | | | | | |
| | material A-4 | | | | | | | |
| | (including foam | | | | | | | |
| | structure) | | | | | | | |
| | Water-soluble material B | 20 | | | | | | |
| | Water-absorbent | | | | | | 20 | |
| | material B | | | | | | | |
| | Antioxidant | 2 | 2 | 2 | 2 | 2 | 2 | 2 |
| | Stearic acid | 1.5 | 1.5 | 1.5 | 1.5 | 1.5 | 1.5 | 1.5 |
| | Zinc oxide | 2 | 2 | 2 | 2 | 2 | 2 | 2 |
| | Sulfur | 1.5 | 1.5 | 1.5 | 1.5 | 1.5 | 1.5 | |
| | Cross-linking agent A | | | | | | | 1.5 |
| | Vulcanization accelerator CZ | 2 | 2 | 2 | 2 | 2 | 2 | 2 |
| | Vulcanization accelerator DPG | 2 | 2 | 2 | 2 | 2 | 2 | 2 |
| Properties•Evaluation | Amount of at least | 13.3 | 0.0 | 0.0 | 0.0 | 0.0 | 13.3 | 0.0 |
| | one of water-soluble | | | | | | | |
| | material B or water- | | | | | | | |
| | absorbent material B/ | | | | | | | |
| | Amount of cross-linking agent | | | | | | | |
| | E*w at 0° C. [MPa] | 3. | 3.8 | 3.5 | 5.0 | 4.6 | 3.5 | 4.5 |
| | E*d at 0° C. [MPa] | 10.0 | 7.0 | 8.3 | 6.0 | 8.5 | 9.0 | 8.0 |
| | E*w at 30° C. [MPa] | 3.3 | 4.0 | 4.5 | 3.6 | 4.0 | 3.7 | 3.0 |
| | E*w at 0° C./E*d at 0° C. | 0.31 | 0.54 | 0.42 | 0.83 | 0.54 | 0.39 | 0.56 |
| | E*w at 30° C./E*w at 0° C. | 1.06 | 1.05 | 1.29 | 0.72 | 0.87 | 1.06 | 0.67 |
| | (a) Ice grip performance | 128 | 115 | 130 | 101 | 105 | 120 | 105 |
| | (b) Dry grip performance | 92 | 115 | 125 | 105 | 112 | 98 | 105 |
| | Overall performance | 220 | 230 | 255 | 206 | 217 | 218 | 210 |
| | (=(a) + (b)) | | | | | | | |
| | | Example | | | | | | |
| | | 16 | 17 | 18 | 19 | 20 | 21 | 22 |
| Amount | NR | 40 | 40 | 40 | 40 | 40 | | 40 |
| (parts | BR | 60 | 60 | 60 | 60 | 60 | 60 | 60 |
| by | SBR | | | | | | 40 | |
| mass) | Carbon black | 10 | 10 | 10 | 30 | 1 | 10 | 10 |
| | Silica | 60 | 60 | 60 | 60 | 60 | 60 | 60 |
| | Silane coupling agent | 5 | 5 | 5 | 5 | 5 | 5 | 5 |
| | Oil | | 25 | 25 | 25 | 20 | 25 | 25 |
| | Plasticizer A | 25 | | | | | | |
| | Temperature-responsive | 20 | 20 | 20 | 10 | 10 | | |
| | material A-1 | | | | | | | |
| | Temperature-responsive | | | | | | 20 | 20 |
| | material A-2 | | | | | | | |
| | (including foam | | | | | | | |
| | structure) | | | | | | | |
| | Temperature-responsive | | | | | | | |
| | material A-3 | | | | | | | |
| | Temperature-responsive | | | | | | | |
| | material A-4 | | | | | | | |
| | (including foam | | | | | | | |
| | structure) | | | | | | | |
| | Water-soluble material B | | 2 | 65 | | | | |
| | Water-absorbent | | | | | | | |
| | material B | | | | | | | |
| | Antioxidant | 2 | 2 | 2 | 2 | 2 | 2 | 2 |
| | Stearic acid | 1.5 | 1.5 | 1.5 | 1.5 | 1.5 | 1.5 | 1.5 |
| | Zinc oxide | 2 | 2 | 2 | 2 | 2 | 2 | 2 |
| | Sulfur | 1.5 | 1.5 | 1.5 | 1.5 | 1.5 | 1.5 | 1.2 |
| | Cross-linking agent A | | | | | | | |
| | Vulcanization accelerator CZ | 2 | 2 | 2 | 2 | 2 | 2 | 2 |
| | Vulcanization accelerator DPG | 2 | 2 | 2 | 2 | 2 | 2 | 2 |
| Properties•Evaluation | Amount of at least | 0.0 | 1.3 | 43.3 | 0.0 | 0.0 | 0.0 | 0.0 |
| | one of water-soluble | | | | | | | |
| | material B or water- | | | | | | | |
| | absorbent material B/ | | | | | | | |
| | Amount of cross-linking agent | | | | | | | |
| | E*w at 0° C. [MPa] | 4.0 | 4.6 | 4.5 | 8.5 | 2.7 | 3.3 | 3.0 |
| | E*d at 0° C. [MPa] | 7.8 | 8.4 | 15.0 | 12.0 | 6.0 | 12.3 | 11.0 |
| | E*w at 30° C. [MPa] | 3.5 | 3.8 | 4.0 | 6.0 | 2.8 | 4.1 | 3.6 |
| | E*w at 0° C./E*d at 0° C. | 0.51 | 0.55 | 0.30 | 0.71 | 0.45 | 0.27 | 0.27 |
| | E*w at 30° C./E*w at 0° C. | 0.88 | 0.83 | 0.89 | 0.71 | 1.04 | 1.24 | 1.20 |
| | (a) Ice grip performance | 110 | 108 | 103 | 100 | 108 | 110 | 125 |
| | (b) Dry grip performance | 110 | 110 | 110 | 112 | 100 | 118 | 98 |
| | Overall performance | 220 | 218 | 213 | 212 | 208 | 228 | 223 |
| | (=(a) + (b)) | | | | | | | |

| | | | | | | | Comparative | |
|---|---|---|---|---|---|---|---|---|
| | | Example | | | | | Example | |
| | | 23 | 24 | 25 | 26 | 27 | 1 | 2 |
| Amount | NR | 40 | 40 | 40 | 40 | 40 | 40 | 40 |
| (parts | BR | 60 | 60 | 60 | 60 | 60 | 60 | 60 |
| by | SBR | | | | | | | |
| mass) | Carbon black | 5 | 10 | 10 | 10 | 10 | 10 | 10 |
| | Silica | 60 | 60 | 60 | 60 | 60 | 60 | 60 |
| | Silane coupling agent | 5 | 5 | 5 | 5 | 5 | 5 | 5 |
| | Oil | 25 | 40 | 25 | 25 | | 25 | 25 |
| | Plasticizer A | | | | | 25 | | |
| | Temperature-responsive | | | | | | | |
| | material A-1 | | | | | | | |
| | Temperature-responsive | 20 | 20 | | 20 | 20 | | |
| | material A-2 | | | | | | | |
| | (including foam | | | | | | | |
| | structure) | | | | | | | |
| | Temperature-responsive | | | | | | | |
| | material A-3 | | | | | | | |
| | Temperature-responsive | | | 20 | | | | |
| | material A-4 | | | | | | | |
| | (including foam | | | | | | | |
| | structure) | | | | | | | |
| | Water-soluble material B | | | | | | | 20 |
| | Water-absorbent | | | | | | | |
| | material B | | | | | | | |
| | Antioxidant | 2 | 2 | 2 | 2 | 2 | 2 | 2 |
| | Stearic acid | 1.5 | 1.5 | 1.5 | 1.5 | 1.5 | 1.5 | 1.5 |
| | Zinc oxide | 2 | 2 | 2 | 2 | 2 | 2 | 2 |
| | Sulfur | 1.5 | 1.5 | 1.5 | | 1.5 | 1.5 | 1.5 |
| | Cross-linking agent A | | | | 1.5 | | | |
| | Vulcanization accelerator CZ | 2 | 2 | 2 | 2 | 2 | 2 | 2 |
| | Vulcanization accelerator DPG | 2 | 2 | 2 | 2 | 2 | 2 | 2 |
| Properties•Evaluation | Amount of at least | 0.0 | 0.0 | 0.0 | 0.0 | 0.0 | 0.0 | 13.3 |
| | one of water-soluble | | | | | | | |
| | material B or water- | | | | | | | |
| | absorbent material B/ | | | | | | | |
| | Amount of cross-linking agent | | | | | | | |
| | E*w at 0° C. [MPa] | 3.1 | 2.8 | 4.8 | 4.2 | 3.7 | 5.0 | 4.5 |
| | E*d at 0° C. [MPa] | 11.0 | 10.5 | 9.0 | 8.5 | 8.4 | 5.0 | 9.0 |
| | E*w at 30° C. [MPa] | 3.8 | 3.5 | 4.3 | 3.3 | 3.9 | 3.5 | 2.7 |
| | E*w at 0° C./E*d at 0° C. | 0.28 | 0.27 | 0.53 | 0.49 | 0.44 | 1.00 | 0.50 |
| | E*w at 30° C./E*w at 0° C. | 1.23 | 1.25 | 0.90 | 0.79 | 1.05 | 0.70 | 0.60 |
| | (a) Ice grip performance | 123 | 130 | 108 | 108 | 113 | 100 | 110 |
| | (b) Dry grip performance | 100 | 95 | 115 | 106 | 115 | 100 | 90 |
| | Overall performance | 223 | 225 | 223 | 214 | 228 | 200 | 200 |
| | (=(a) + (b)) | | | | | | | |

The present disclosure (1) relates to a tire rubber composition, containing:
a rubber component including at least one selected from the group consisting of polyisoprene rubber, polybutadiene rubber, and styrene-butadiene rubber;
a cross-linking agent;
carbon black;
a plasticizer; and
a temperature-responsive material A containing a carboxyl group-containing polymer and a metal salt,
the tire rubber composition containing, per 100 parts by mass of the rubber component, the cross-linking agent in an amount of more than 0 parts by mass and less than 10 parts by mass, the carbon black in an amount of more than 0 parts by mass and less than 100 parts by mass, and the plasticizer in an amount of more than 5 parts by mass.

The present disclosure (2) relates to the tire rubber composition according to the present disclosure (1), further containing at least one of a water-soluble material B or a water-absorbent material B.

The present disclosure (3) relates to the tire rubber composition according to the present disclosure (2),
wherein a ratio of the amount of the material B to the amount of the cross-linking agent (amount of material B/amount of cross-linking agent) is 2.0 to 40.0.

The present disclosure (4) relates to the tire rubber composition according to any one of the present disclosures (1) to (3),
wherein the tire rubber composition has a dynamic modulus of elasticity when immersed in water at 0° C. (E*w at 0° C.), a dynamic modulus of elasticity when immersed in water at 30° C. (E*w at 30° C.), and a dynamic modulus of elasticity when dry at 0° C. (E*d at 0° C.) which satisfy the following formulas (1) and (2):

$$E * w at 0 ° C . / E * d at 0 ° C . \leq 0.7 \qquad ( 1 )$$

$$E * w at 30 ° C . / E * w at 0 ° C . \geq 0.8 . \qquad ( 2 )$$

The present disclosure (5) relates to the tire rubber composition according to any one of the present disclosures (1) to (4),
wherein the tire rubber composition has a dynamic modulus of elasticity when immersed in water at 0° C. (E*w at 0° C.) satisfying the following formula:

$$E * w at 0 ° C . \leq 8. MPa .$$

The present disclosure (6) relates to the tire rubber composition according to any one of the present disclosures (1) to (5),
wherein the tire rubber composition has a dynamic modulus of elasticity when immersed in water at 30° C. (E*W at 30° C.) satisfying the following formula:

$$E * w at 30 ° C . \geq 3. MPa .$$

The present disclosure (7) relates to the tire rubber composition according to any one of the present disclosures (1) to (6),
wherein the temperature-responsive material A is a material including at least partially a foam structure.

The present disclosure (8) relates to a tire including a tread including the rubber composition according to any one of the present disclosures (1) to (7).

The present disclosure (9) relates to the tire according to the present disclosure (8), which is a winter tire or an all-season tire.

1. A tire rubber composition, comprising:
a rubber component including at least one selected from the group consisting of polyisoprene rubber, polybutadiene rubber, and styrene-butadiene rubber;
a cross-linking agent;
carbon black;
a plasticizer; and
a temperature-responsive material A containing a carboxyl group-containing polymer and a metal salt,
the tire rubber composition comprising, per 100 parts by mass of the rubber component, the cross-linking agent in an amount of more than 0 parts by mass and less than 10 parts by mass, the carbon black in an amount of more than 0 parts by mass and less than 100 parts by mass, and the plasticizer in an amount of more than 5 parts by mass.

2. The tire rubber composition according to claim 1, further comprising at least one of a water-soluble material B or a water-absorbent material B.

3. The tire rubber composition according to claim 2,
wherein a ratio of the amount of the material B to the amount of the cross-linking agent (amount of material B/amount of cross-linking agent) is 2.0 to 40.0.

4. The tire rubber composition according to claim 1,
wherein the tire rubber composition has a dynamic modulus of elasticity when immersed in water at 0° C. (E*w at 0° C.), a dynamic modulus of elasticity when immersed in water at 30° C. (E*w at 30° C.), and a dynamic modulus of elasticity when dry at 0° C. (E*d at 0° C.) which satisfy the following formulas (1) and (2):
$$E * w at 0 ° C . / E * d at 0 ° C . \leq 0.7 \qquad ( 1 )$$
$$E * w at 30 ° C . / E * w at 0 ° C . \geq 0.8 . \qquad ( 2 )$$

5. The tire rubber composition according to claim 1,
wherein the tire rubber composition has a dynamic modulus of elasticity when immersed in water at 0° C. (E*w at 0° C.) satisfying the following formula:
$$E * w at 0 ° C . \leq 8. MPa .$$

6. The tire rubber composition according to claim 1,
wherein the tire rubber composition has a dynamic modulus of elasticity when immersed in water at 30° C. (E*w at 30° C.) satisfying the following formula:
$$E * w at 30 ° C . \geq 3. MPa .$$

7. The tire rubber composition according to claim 1,
wherein the temperature-responsive material A is a material including at least partially a foam structure.

8. A tire, comprising a tread including the rubber composition according to claim 1.

9. The tire according to claim 8, which is a winter tire or an all-season tire.
